(19) United States
(12) Patent Application Publication
(10) Pub. No.: US 2015/0315459 A1
(43) Pub. Date: Nov. 5, 2015

(54) Flash Coating Treatments For Proppant Solids

(71) Applicant: Preferred Technology, LLC, Radnor, PA (US)

(72) Inventors: Robert McDaniel, Cypress, TX (US); Kerry Drake, Red Hill, PA (US); Spyridon Monastiriotis, Houston, TX (US); Ralph Barthel, Magnolia, TX (US)

(21) Appl. No.: 14/798,774

(22) Filed: Jul. 14, 2015

Related U.S. Application Data
(63) Continuation of application No. 14/528,070, filed on Oct. 30, 2014.
(60) Provisional application No. 61/904,833, filed on Nov. 15, 2013.
(60) Provisional application No. 61/898,324, filed on Oct. 31, 2013.

(51) Int. Cl. C09K 8/80

(52) U.S. Cl. CPC C09K 8/805

(57) ABSTRACT

Treatment methods for coated or uncoated proppants that can, among other things, control fugitive dust during typical handling procedures with typical transport equipment and/or add functional features to the proppant solid are disclosed herein.

### CROSS-REFERENCE TO RELATED APPLICATIONS

The present application is a continuation of U.S. application Ser. No. 14/528,070, filed Oct. 30, 2014, which claims priority to U.S. provisional patent application Ser. No. 61/904,833, filed on Nov. 15, 2013 and U.S. provisional patent application Ser. No. 61/898,324 filed on Oct. 31, 2013, the disclosures of each of which are hereby incorporated by reference.

### FIELD

Embodiments disclosed herein relate to, for example, treatments for coated or uncoated proppants that can, among other things, control fugitive dust during typical handling procedures with typical transport equipment and/or add functional features to the proppant solid.

### BACKGROUND

Dust generated by the handling of proppant (both coated and uncoated) has been an area of concern for a number of years. The dust can be a nuisance, a health hazard and also disrupt production of oil and gas products produced during the fracturing process. Prior methods of controlling dust have not been sufficient.

Defects in the manufacturing process for proppants have been attempted to be cured by the use of additives or increased washing. However, they have not been effective while maintaining the necessary properties of the proppant (e.g. flow and strength). Examples can be found, for example, in U.S. Pat. No. 7,270,879, which shows dust being generated that would likely be a nuisance but should be avoided. In addition, a variety of methods can be used to decrease the effects of the dust, which include, for example, mechanical isolation (e.g., masks), atmospheric venting and other containment strategies to reduce exposure to the dusts of the operations. These methods, however, do not reduce dust, but rather reduce the effect of the dust.

Prior methods for reducing dust include converting the potential dust source into a solid, paste or liquid. However, none of these would be acceptable for frac proppants or sands which must remain dry and free-flowing for use with existing pneumatic and dry solids material transfer handling equipment. This same requirement effectively eliminates the use of conventional wet treatments that make the particulates perceptibly wet to the eye and touch. Such wetness in finely divided solids causes clumping, aggregation and enhanced difficulties with gravity-fed discharge system or pneumatic conveyance equipment. Other chemical methods are described, for example, in U.S. Pat. No. 5,480,584 and U.S. Pat. No. 7,270,879, but the process is not suitable for frac proppants or sands because the proppants would clump, aggregate, or would otherwise materially change their the free-flowing characteristics so that conventional pneumatic conveyance equipment exhibits a diminished or compromised effectiveness. The processes can also not be very cost effective.

Accordingly, fugitive proppant dust presents unique treatment and control issues relative to other forms of dust. For example, road surfaces are generally fixed in position so that treatments can be applied and allowed a period of time to penetrate and set. Coal mines similarly see a fixed treatment surface. Proppants are often moved, usually by gravity discharge or pneumatic conveyance, and rely heavily on a free-flowing form to be loaded and discharged with conventional handling equipment. Proppants should also be chemically compatible with, and wettable by, frac fluids that have relatively complex physical and chemical properties to be effective. Thus, traditional forms of dust control have not been sufficiently effective when used with proppants. Therefore, there is a need for improved products and processes for controlling dust. Additionally, there is a need to functionalize proppants by including functional molecules in any coating that is applied to the proppant to control the dust. The embodiments disclosed herein satisfy these needs as well as others.

### SUMMARY

Embodiments disclosed herein provide methods for treating proppant solids (e.g., coated or uncoated frac sands, bauxite, ceramic and the like) with a liquid treatment agent that can suppress or reduce the formation and release of dust. In some embodiments, the methods do not adversely affect the wettability, free-flowing character, or proppant performance of the treated solids when the treated solids are used as proppants in a well.

Embodiments disclosed herein provide methods that can apply a liquid treatment agent quickly, on-the-fly during transport and/or discharge and without necessarily using an installed manufacturing facility. Therefore, in some embodiments, the method can be performed in a transfer vessel, at a manufacturing site, or at any point in the transfer or discharge process and/or before use at a well site.

In some embodiments, the method is performed with proppants after the proppants have been collected from a bulk storage site and during the process of loading, transport to, or unloading for delivery at a wellsite. In some embodiments, the method allows the treated proppant to retain its free-flowing characteristics for continued use of conventional pneumatic handling equipment. In some embodiments, the method is performed without adversely affecting its use in conventional fracturing fluids. In some embodiments, the method comprises contacting one or more proppant solids with a coating composition during one or more of such steps where the coating composition forms a protective coating within seconds of its application that controls fugitive dust from the coated proppants. In some embodiments, the coating provides coated proppants with a functional benefit, other than reducing dust production or release. In some embodiments, the coating includes or is a hydrophobic coating. Examples of additional functional features that can be added to proppants using embodiments described herein include, but are not limited to, scale inhibition, friction reduction, tracer-containing coatings, impact modifiers, controlled delivery of chemical additives, sulfide control, composite coatings, staged and time release coatings, coatings that are acid and base-resistant, corrosion inhibition agents, additives that improve crush resistance, agents that inhibit paraffin or asphaltene deposits, coatings that improve conductivity, and coatings for the removal of targeted anions and halogens from produced fluids.

In some embodiments, the method comprises contacting finely divided proppant solids (e.g. sized sand or ceramic particulates) with a liquid treatment agent comprising one or more of: (a) monosaccharide and/or polysaccharide solutions, (b) low molecular weight mineral oils, (c) vegetable oils, (d) mixtures of polyethylene and oil, (e) C₆-C₁₆ alkoxylated alcohols, (f) polymer and copolymer mixtures containing one or more ionic and nonionic acrylic polymers, acrylate polymers, acrylamide polymers, vinyl acetate polymers, styrene/acrylic acid/acrylonitrile copolymers, (f) crosslinked guar gum, (g) carboxymethylcellulose, (h) starch, (i) psyllium powder, (j) potassium-based superabsorbent polymers, (k) copolymers, and (l) mixtures of the preceding.

Embodiments described herein can be used to quickly coat frac sands, ceramics, bauxite and other, finely divided, solids that are used in hydraulic fracturing or similar industries that make use of gravity feeder systems, belt conveyors, and pneumatic conveyance devices. The methods described herein can be used to suppress the formation of fugitive dust, prevent existing dust that might cling to the surfaces of the solids or which is intermingled in the bulk solids from becoming airborne, preserve the sphericity and integrity of the treated solids, substantially reduce or avoid the generation of fugitive dust emissions from the conveyed solids while maintaining free-flowing characteristics by the treated particle, and/or add functional chemical effects to the treated proppants.

Embodiments described herein provide processes for treating free-flowing, finely divided proppant solids. In some embodiments, the processes comprises contacting the solids less than five seconds with a liquid treatment agent with an amount of the liquid treatment agent that substantially retains free-flowing characteristics of the treated solids. In some embodiments, the solids are contacted with the liquid treatment agent more than once and each contacting step is for less than five seconds.

In some embodiments, the contacting comprises spraying solids substantially simultaneously from more than one direction. In some embodiments, the solids are contacted for less than two seconds with the liquid treatment agent. In some embodiments, the solids are contacted for less than one second with the liquid treatment agent. In some embodiments, the solids are contacted with the liquid treatment agent for the time it takes the solids to fall a distance of four feet.

In some embodiments, the liquid treatment agent comprises a polysaccharide solution. In some embodiments, the liquid treatment agent comprises a C₆-C₁₆ alkoxylated alcohol. In some embodiments, the liquid treatment agent comprises at least one acrylic polymer. In some embodiments, the liquid treatment agent comprises an acrylic copolymer. In some embodiments, the liquid treatment agent comprises a mixture of at least one C₆-C₁₆ alkoxylated alcohol and at least one acrylic polymer.

In some embodiments, the liquid treatment agent is applied to the solids in an amount of less than 1 wt % per weight based on the weight of the proppant solids. In some embodiments, the liquid treatment agent is contacted with the solids in an amount of less than 0.5 wt %. In some embodiments, the liquid treatment agent is contacted with the solids in an amount of less than 0.35 wt %. In some embodiments, the liquid treatment agent is contacted with the solids in an amount of less than 0.25 wt %.

In some embodiments, the liquid treatment agent is contacted with the solids immediately before, concurrently with, or immediately after passing the solids through a static mixer.

In some embodiments, the contacting step comprises: applying a first liquid treatment agent with a first spray assembly onto the solids for less than five seconds; passing the treated solids through a static mixer; and applying a second liquid treatment agent with a second spray assembly onto the solids for less than five seconds. In some embodiments, the first liquid treatment and the second liquid treatment are different solutions. In some embodiments, the second liquid treatment is applied to the solids immediately after the solids are passed through the static mixer. In some embodiments, at least one of the first and second liquid treatment agents is effective to coat the solids with a dust reduction coating.

In some embodiments, at least one of the first and second liquid treatments is effective to coat the solids with an additional coating. In some embodiments, the additional coating is one or more of: a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, or a coating comprising an ion exchange resin that removes anions and/or halogens, or any combination thereof.

The present disclosure also provides coated, free-flowing proppants comprising a dried and/or cured coating that comprises less than about 3 wt % of a treating agent. In some embodiments, the coated, free-flowing, proppant exhibits reduced fugitive dust generation as compared to the uncoated proppant. In some embodiments, the coated, free-flowing proppants comprise 0.0009-0.5 wt % of the coating. In some embodiments, the coated, free-flowing proppants comprise 0.001-0.35 wt % of the coating. In some embodiments, the coating comprises one or more of: monosaccharides or polysaccharides, surfactants, alkoxylated alcohols, acrylic polymers, methacrylic polymers, copolymers of acrylic acid and/or methacrylic acid, methacrylates and copolymers thereof, polyvinyl acetates, vinyl acrylic copolymers, polybutadiene, low molecular weight mineral oils, acrylamide polymers, lignosulfonates, water-dispersible natural gums, water-dispersible pectins, water-dispersible starch derivatives, water-dispersible cellulose derivatives, or any mixture thereof. In some embodiments, the coating comprises one or more monosaccharides or polysaccharides. In some embodiments, the coating comprises one or more alkoxylated alcohols. In some embodiments, the coating comprises at least one C₆-C₁₂ alkoxylated alcohol and at least one C₁₀-C₁₆ alkoxylated alcohol. In some embodiments, the coating comprises one or more acrylic polymers. In some embodiments, the coating comprises at least one C₆-C₁₂ alkoxylated alcohol, at least one C₁₀-C₁₆ alkoxylated alcohols, and at least one acrylic polymer. In some embodiments, the coating comprises one or more methacrylic polymers, one or more copolymers of acrylic acid and/or methacrylic acid, and one or more of methacrylates. In some embodiments, the coating comprises any one or more of: a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, and/or a coating comprising an ion exchange resin that removes anions and/or halogens, or any combination thereof. In some embodiments, the coating further comprises a sulfide scavenger or scale inhibitor.

### BRIEF DESCRIPTION OF THE DRAWINGS

FIG. 1 is a diagram showing the types of equipment and process flow sequence described herein.

FIG. 2 shows a representative spray point in an optional static mixer that can be used as described herein.

FIG. 3 shows the outside of a static mixer and the representative locations of a series of static mixing bars helically arranged within the static mixer.

FIG. 4 is a view downwardly through a static mixer that shows the helical disposition of static mixing bars disposed within the mixer.

FIG. 5 shows the use of a series of spray nozzles located around the perimeter of a ring disposed around a discharge spout in a proppant handling facility.

FIG. 6 is a side view of the ring sprayer shown in FIG. 5.

FIG. 7 shows a configuration that combines the sprayer assembly of FIGS. 5 and 6 with the drum-shaped static mixer of FIGS. 3 and 4.

FIG. 8 shows an alternative configuration in which spray nozzles precede and follow a static mixer.

FIG. 9 illustrates non-limiting embodiments of a vertical treatment mixer that combines a partially enclosed, upper spray section above a static mixing section followed by a lower, inwardly tapered discharge section.

FIG. 10 illustrates non-limiting embodiments of a vertical treatment mixer that combines a partially enclosed, upper spray section above a static mixing section followed by a lower, inwardly tapered discharge section.

FIG. 11 illustrates non-limiting embodiments of a vertical treatment mixer that combines a partially enclosed, upper spray section above a static mixing section followed by a lower, inwardly tapered discharge section.

FIG. 12 illustrates non-limiting embodiments of a vertical treatment mixer that combines a partially enclosed, upper spray section above a static mixing section followed by a lower, inwardly tapered discharge section.

### DESCRIPTION

Embodiments disclosed herein provide methods and compositions for treating frac sands, whether or not provided with a cured coating, as well as other finely divided proppant solids (e.g., resin-coated sand, bauxite or ceramics), that are effective for reducing the amount of fugitive dust associated with processing, handling, transporting and using, for example, such finely divided proppant materials in hydraulic fracturing.

Embodiments disclosed herein also provide methods that reduce fugitive dust associated with the proppant material itself and do not require users, transporters and well sites to purchase or use additional equipment to handle the thus-treated solids.

Embodiments disclosed herein provide compositions and methods for maintaining or improving performance of the proppant solids pack by reducing loss of sphericity and/or minimizing the inclusion of fine particles that could affect the performance of the proppant solids.

Embodiments disclosed herein provide methods for treating a proppant quickly and with minimal effect on the conventional handling techniques and equipment currently in use for loading, moving, and unloading coated or uncoated proppant sands or ceramics.

Embodiments disclosed herein include, but are not limited to, free-flowing proppant solids being treated with a liquid treatment agent quickly and at a sufficiently low application rate in order to maintain the free-flowing properties of the treated solids. Without wishing to be bound by any particular theory, such low levels of treatment with the agents allow the treated solids to be handled with conventional handling equipment without adversely affecting the handling and conveying process. The treatment agent can also help to avoid the degradation or deterioration of the proppant solids. Some of the unexpected advantages of the processes and compositions described herein include, but are not limited to, preserving sphericity and the crush resistance benefits associated with the proppants while avoiding the formation of fines (e.g. dust) that can become an airborne health hazard or in a high enough concentration to affect the properties of the fracturing fluid. Embodiments described herein can also be used to provide the proppant with additional functions and/or benefits of value for oil and gas well operation by incorporating functional molecules into the coating.

Advantages of the embodiments described throughout and others would be readily apparent to one of skill in the art. In addition, certain advantages, the embodiments described herein include, but are not limited to, that the method that protects the proppant grains from the abrasion during handling or pneumatic transfer can also help to reduce wear on the pneumatic trucks that transport the sand for the transload to the wellsite. Thus, embodiments described herein not only help to control fugitive dust but also limit the wear on pipes and fittings used in moving and handling the solids. The embodiments described herein can also be effective in reducing the wear on the high pressure pipes and fittings that connect the discharge end of the high pressure pumps to a wellhead. For example, because a large amount of proppant is pumped, the high pressure pipes and fittings must be tested frequently to determine the effect of proppant abrasion on that strength. The embodiments described herein can help to reduce the wear on the equipment and thereby increase its useful life.

Controlling fugitive dust from frac sands and other proppants can be accomplished by methods and processes described herein. In some embodiments, the processes comprise contacting finely divided proppant solids with a liquid treatment agent at an amount that is sufficient to suppress fugitive dust emissions from the treated solids and/or impart additional functional chemical benefits while still maintaining the freely flowing character of the treated solids, like those of the proppants before treatment, that continues to allow the effective use of gravity feed, pneumatic and belt conveyor handling systems. In some embodiments, the treatment occurs in 10 seconds or less and while the solids are in free fall, guided free fall (as in falling through a static mixer), or during pneumatic conveyance. During these periods, the free-flowing properties of the solids make them particularly amenable to contact with one or more dispersive liquid sprays and turbulent mixing.

Even when treated at an amount less than that required to make the solids perceptibly wet, i.e., in an amount of less than 0.7 wt % moisture to preserve free-flowing characteristics, or in some embodiments from 0.05-0.4 wt %, dust emissions are substantially reduced and what particulates are ejected due to discharge impact quickly settle. Such performance allows treated proppants to continue to be handled effectively with existing handling equipment like gravity-based discharge systems, moving belts, pneumatic conveyance systems, etc.

The solids that can be treated are, and remain, finely divided, free-flowing, solids that generally have a size of about 0.2 mm to about 1 mm. Such solid sizes are used in hydraulic fracturing to prop open cracks formed downhole within the fractured strata. Such crack props, or “proppants” as they are known, must resist the crushing forces of crack closure to help maintain the flow of liquids and gases that have been trapped in the strata. Materials often used as proppant include coated and uncoated sand, bauxite, and ceramic proppant materials. All such materials are suitable for use in the methods and processes described herein.

In some embodiments described herein, embodiments use a liquid treatment agent that is applied at extremely low levels, e.g., at levels that avoid making the particulates perceptibly wet such as observed by, e.g., drips, puddles, a visible wet sheen or a wet “feel” upon handling the treated solids. In some embodiments, some treatments might require mild drying after contact with the sprayed treating agent in order to avoid “perceptibly wet” particles, especially those prepared using non-aqueous based solvent carriers.

In some embodiments, the treatment agent level is also fast and sufficiently low in applied volumes to avoid the formation of firmly agglomerated masses of treated solids that are not readily transported by conventional dry proppant solids handling equipment, e.g., gravity-fed conveying systems, pneumatic transport, and the like. In other words, the proppant solids that are treated according to the presently disclosed methods continue to act and be subject to handling by conventional proppant solids handling equipment and systems. In some embodiments, the liquid treatment agent is applied or contacted with the solids for less than or equal to 20, 19, 18, 17, 16, 15, 14, 13, 12, 11, 10, 9, 8, 7, 6, 5, 4, 3, 2, or 1 seconds. As used herein, the phrase “less than” when used in reference to a certain of period of time does not include zero unless explicitly stated. In some embodiments, the liquid treatment agent is contacted with the solids for about 0.1 to about 5 seconds, about 0.1 to about 10 seconds, about 0.1 to about 15 seconds, or about 0.1 to about 20 seconds. In some embodiments, the liquid treatment agent is contacted with the solids for about 1 to about 10, about 1 to about 9, about 1 to about 8, about 1 to about 7, about 1 to about 6, about 1 to about 5, about 1 to about 4, about 1 to about 3, or about 1 to about 2 seconds. In some embodiments, the liquid treatment agent is contacted with the solids for about 0.5 to about 10, about 0.5 to about 9, about 0.5 to about 8, about 0.5 to about 7, about 0.5 to about 6, about 0.5 to about 5, about 0.5 to about 4, about 0.5 to about 3, about 0.5 to about 2, or about 0.5 to about 1 seconds. In some embodiments, the liquid treatment agent is contacted with the solids for about 2 to about 10, about 2 to about 9, about 2 to about 8, about 2 to about 7, about 2 to about 6, about 2 to about 5, about 2 to about 4, or about 2 to about 3 seconds. In some embodiments, the liquid treatment agent is contacted with the solids for about 3 to about 10, about 3 to about 9, about 3 to about 8, about 3 to about 7, about 3 to about 6, about 3 to about 5, or about 3 to about 4 seconds. In some embodiments, the liquid treatment agent is contacted with the solids for about 4 to about 10, about 4 to about 9, about 4 to about 8, about 4 to about 7, about 4 to about 6, or about 4 to about 5 seconds. The time periods described herein can be used in conjunction with any embodiment of the processes described herein involving the contacting of a solid with a liquid treatment agent. The phrase “time period as described herein” refers to these time periods in addition to any time periods described specifically with any particular embodiment.

In some embodiments, the liquid treatment agent is presented as an aqueous solution, dispersion, or emulsion. In some embodiments, suitable levels of the liquid treatment agent can be characterized as a weight of applied solids per unit weight of treated solids. In some embodiments, with such a reference frame, suitable application rates of liquid treatment agent are less than 5 wt % treating agent solids per unit weight of treated solid (e.g. sand). In some embodiments, the liquid treatment agent is applied at a rate of less than about 3 wt % and without adversely affecting free-flowing characteristics by the treated proppants after the applied materials have dried. In some embodiments, the treatment agent is applied at an amount from about 0.0002 to about 1.5 wt %, about 0.0002 to about 1 wt %, about 0.0005 to about 0.85 wt %, about 0.0007 to about 0.75 wt %, about 0.0008 to about 0.65 wt %, about 0.0009 to about 0.5 wt %, about 0.001 to about 0.35 wt % and about 0.0013 to about 0.25 wt %. In some embodiments, the amount of the liquid treatment agent is from about 3 to about 8 lb of the liquid treatment agent per ton of proppant solid. In some embodiments, the solids can be contacted with the liquid treatment agent at a rate of about 400 tons/hour at commercial application rates depending on the equipment used. In some embodiments, the about 3 to about 8 lb of treatment agent is based upon a dispersion that has about 40% solids.

As described herein, the solids are contacted with the liquid treatment agent very quickly thereby making the process amenable to treatment rapidly, “on-the-fly”, at loading, handling in transport or at unloading events. As described herein, the solids can be contacted with the treatment for short periods of time, which include, but are not limited to for a period of time that is less than five seconds, but greater than zero. In some embodiments, the time period is about 1 to about 3 seconds. In some embodiments, the solids are contacted with the liquid treatment agent in the time it takes the solids to fall 3-4 feet (1-1.3 m). In some embodiments, the liquid treatment agent is contacted with the solids using a spray dispersion nozzle. In some embodiments, the liquid treatment agent is contacted with the solids via a plurality of spray dispersion nozzles that impinge on a falling or guided falling stream of proppants, or which introduce the liquid treatment agent onto the proppant solids as the solids are pneumatically conveyed for loading or unloading.

The liquid treatment agent can be contacted with the solids in any way that is effective to provide the solids with a substantially uniform dispersion of liquid treatment agent over as much of the solids within the treatment zone as is reasonably possible. The methods can be dependent, for example, on the existing equipment, budget and space. In some embodiments, the contacting equipment is a spraying system of at least one nozzle that distributes the liquid treatment agent over, under, around and within the treated solids as they move past and through the treatment zone. In some embodiments there are a plurality of nozzles.

In some embodiments, a typical treatment zone might be located along a conveyor belt as proppants are unloaded from a transport vehicle and conveyed by a belt to discharge equipment. In some embodiments, a treatment zone includes 1 to 8 nozzles and/or atomizing spray nozzles, to create a fine spray, mist or fog that contacts the moving proppants from both above and below the conveyor belt or as the solids fall from the conveyor belt to effect a substantially uniform treatment.

In some embodiments, the treatment zone could be within an enclosure located around the conveying system/belt to better contain the treatment additive as it is applied, to better control the environment around the application point, or to make the contacting process more efficient.

The proppant solids can also be heated or allowed to become heated to an elevated temperature, i.e., at a temperature above 25° C. or from about 30° to about 85° C., immediately before or after the contacting step so that higher concentrations of the liquid treatment agent can be applied to increase performance or allow a less expensive additive to be utilized.

In some embodiments, another treatment zone might be located in or in conjunction with a pneumatic conveyor. One or more spray nozzles (e.g. fine spray nozzles) can be aligned and directed to discharge the liquid treatment agent into the pneumatic air stream at one or more locations at the appropriate injection rate so as to contact the conveyed solids as they are mixed and moving in the conveyance stream.

In some embodiments, treatment zones are located at one or more transfer points within the handling process where the solids are in motion and sufficient mixing can be performed readily. In some embodiments, they are mixed with a static mixer to enhance mixing of the treated solids and encourage a substantially even distribution of the liquid treatment agent over the solids. In some embodiments, the locations include loading ports where stored proppant solids are delivered for transport to a delivery truck, discharge ports used for loading pneumatic transport trucks, and discharge belts when a truck unloads proppants at a well site. In some embodiments, the process comprises applying a first liquid treatment agent with a first spray assembly onto the solids for a period of time as described herein; passing the treated solids through a static mixer; and applying a second liquid treatment agent with a second spray assembly onto said solids for a period of time as described herein. In some embodiments, the first liquid treatment and the second liquid treatment are different solutions. In some embodiments, the second liquid treatment is applied to the solids immediately after the solids are passed through the static mixer. In some embodiments, at least one of the first and second liquid treatment agents is effective to coat the solids with a dust reduction coating. In some embodiments, at least one of the first and second liquid treatments is effective to coat the solids with an additional coating. In some embodiments, the additional coating is a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, or a coating comprising an ion exchange resin that removes anions and/or halogens. Such coatings are described herein, but other coatings can also be applied.

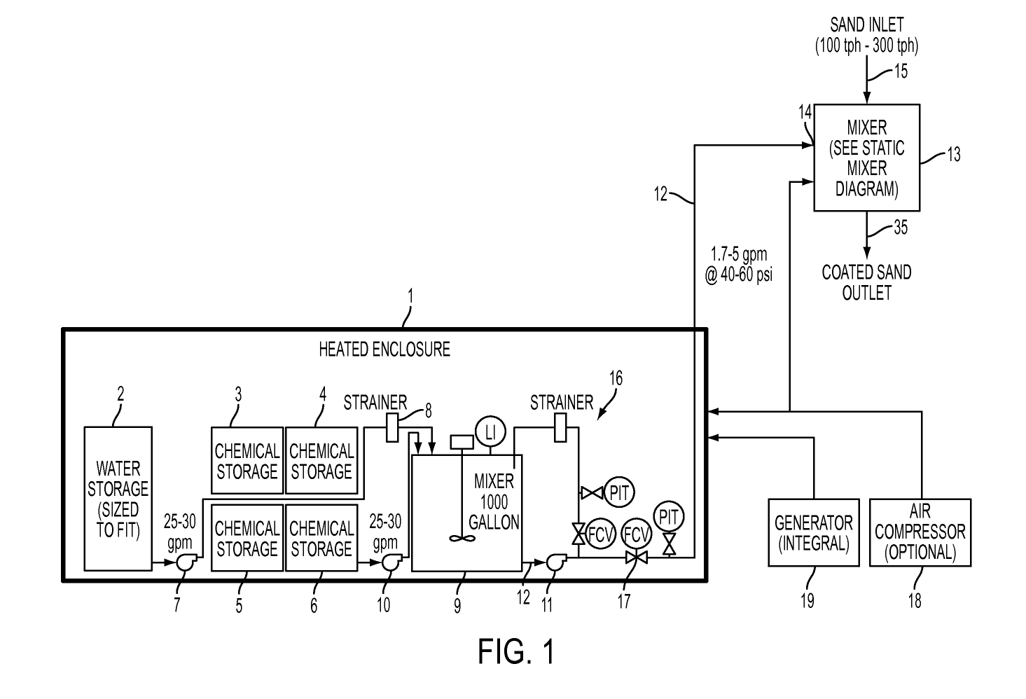

In some embodiments, the liquid treatment agent is contacted and mixed with the proppant solids at a transfer point location where the proppant solids are discharged and experience some period of free fall to a vertically lower point. Such locations permit the use of one or more spray nozzles. For example, 1 to 12 nozzles in 1 to 3 stages can be disposed around the falling solids such as around a discharge port in a substantially circular pattern. In some embodiments, multiple nozzles are used. In some embodiments, multiple nozzles are used each with a fan-shaped or conical spray pattern that are aligned and aimed to spray the falling solids with the liquid treatment agent and coat the solids. In some embodiments, the contacting occurs immediately before, during, and/or after passage through a static mixer that uses the momentum of the falling solids to encourage better mixing and distribution of the liquid treatment agent over the solids. In some embodiments, a diagram of such a process is shown is illustrated in FIG. 1.

As shown, an insulated and/or heated enclosure (1) protects the water storage tank (2) and liquid treatment agent concentrate storage units (3), (4), (5), (6) from substantial variations in ambient temperature. A pump (7) is used to move water from a storage tank (2) through a strainer (8) into a liquid treatment agent mixer (9). A pump (10) delivers the liquid treatment agent from the storage units (3-5) to the mixer (9), or to a point immediately above and preceding the mixer (9), at a controlled rate sufficient to meet the desired concentration rate for use in the presently disclosed methods. A pump (11) is used to transfer the diluted liquid treatment agent (12) to a mixer (13) and dispersed with one or more spray nozzles (14) at, e.g., a rate within the range of 1.7-5 gallons per minute at 40-60 psi when treating sand moved at typical commercial volumes of, e.g., 100-400 tons per hour. The proppant sand (15) is delivered to the top of the mixer (13) which is suitably a static mixer sized to handle commercial volumes of sand, where the proppant sand (15) is mixed with the liquid treatment agent issuing from the first spray assembly of spray nozzles (14).

A recirculation circuit (16) can be used to keep the liquid treatment agent in motion within the conduits if a valve (17) is closed.

An optional air compressor (18) can be used to provide a source of pressurized air to the enclosure (1) and/or the mixer (13). An optional power generator (19) serves as a source of backup power for the enclosure (1), including the pumps (7), (10), (11) and the mixer (9).

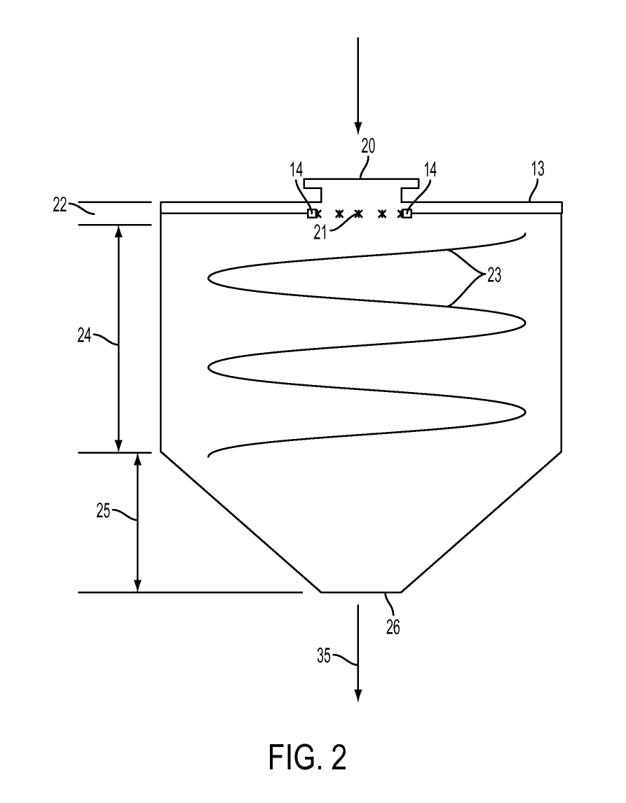

A mixer (13), such as a static sand mixer, is shown in somewhat more detail in FIG. 2. In this view, liquid treatment agent (12) is passed through nozzles (14) surrounding a sand inlet (20) of the mixer (13) where the liquid treatment agent (12) contacts the sand (21) as it passes through a spraying zone (22). The sand (21) then contacts a series of mounted, impingement-type, rods or mixing members (23) that are located throughout the vertical height of the mixing zone (24). In some embodiments, the mixing members (23) are round, ovoid, curved, ramp-shaped, triangular, square (suitably disposed with an edge pointed upwardly) or diamond-shaped, or otherwise chosen to exhibit a cross-sectional shape that serves to re-direct or direct individual grains of sand (21) as they fall through the mixing zone (24) and thereby effect a mixing action. By impingement and deflection off of the lateral surfaces of rounded mixing members (23), the liquid treatment agent (12) on the sand (21) is re-distributed to more evenly distribute the liquid treatment agent across the bulk of the sand (21) in a manner that is substantially uniform. The use of pipes or rods with a sufficient material hardness to resist the abrasive effects of falling sand are shown to facilitate construction and maintenance as members (23) become worn.

In some embodiments, the mixing members (23) are releasably connected, secured or retained within the mixer (13) by a suitable fastener or bracket to retain the members (23) within the mixer (13) despite the friction and forces of sand falling there through. Suitable fasteners can include, but are not limited to, bolts into the members (23) in a horizontal direction, transverse bolts that secure the members (23) to the mixer (13) with one or more flanges or brackets that are themselves secured, welded or connected to the lateral walls of the mixer (13), or retention brackets (not shown) having a U- or L-shape into which the member (23) is secured from vertical movement.

In some embodiments of the mixer (13), there is a transition zone (25) that allows the treated sand to settle before discharge through an outlet (26). Such a transition also serves to reduce the momentum of the discharged sand and thereby limit the forces that might serve to eject fugitive dust as the falling, treated sand is deposited.

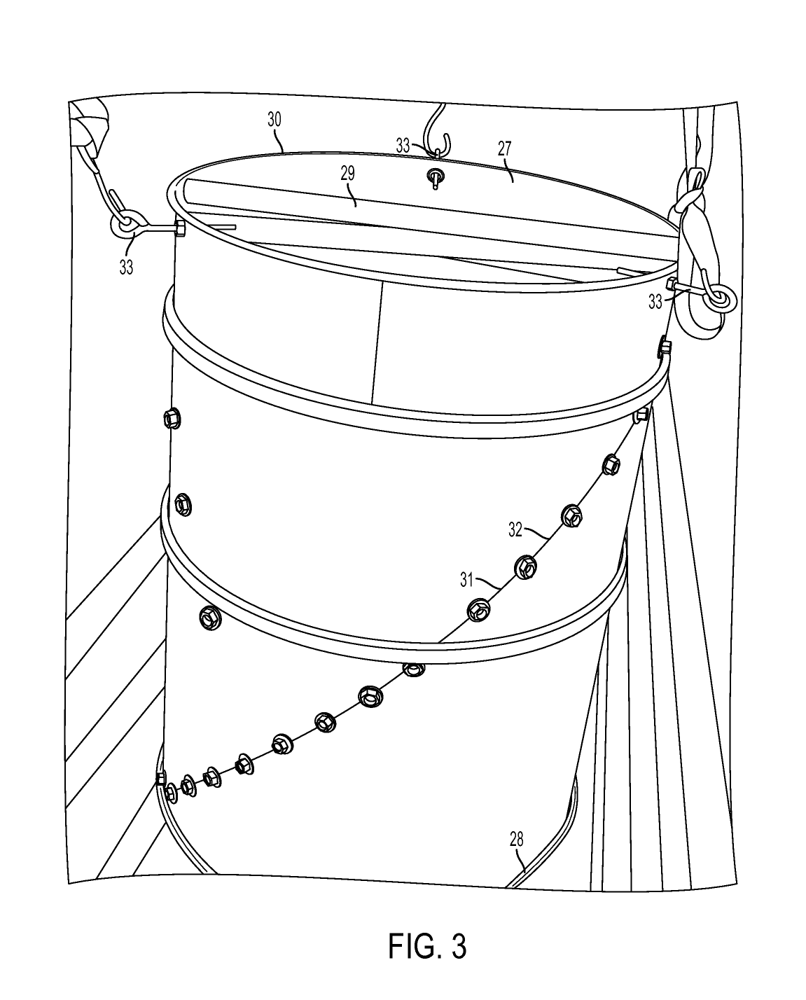

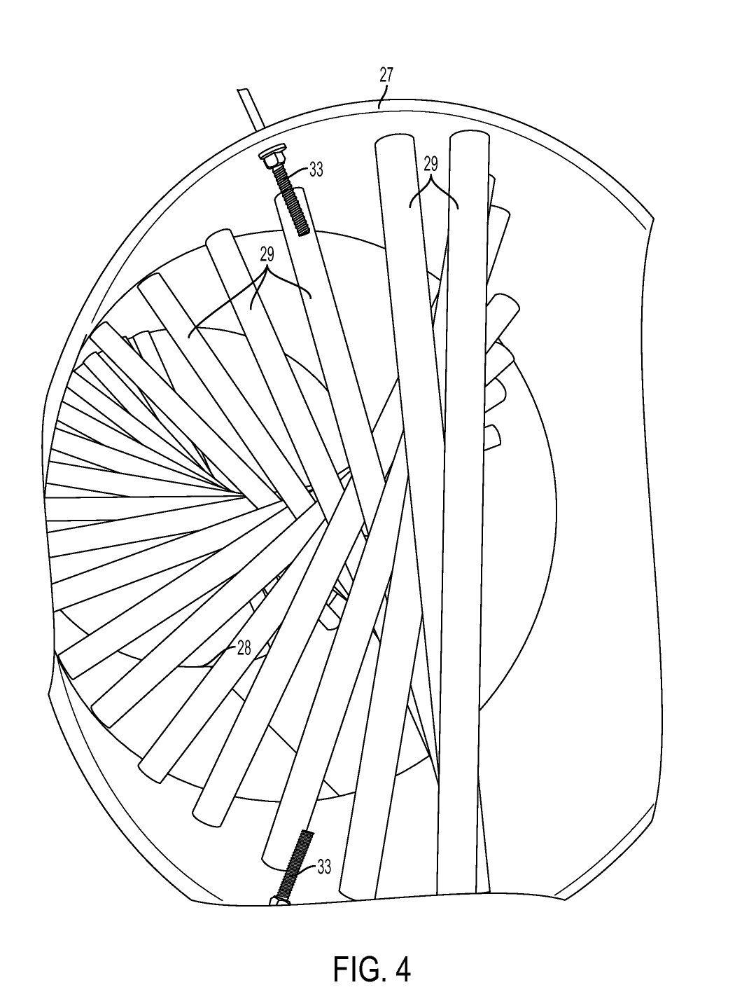

An acceptable, alternative type of static mixer (13) is shown in FIGS. 3 and 4. The static mixer shown is substantially cylindrical in shape (like a 55 gallon drum where the top inlet (27) is substantially the same diameter as the bottom outlet (28)) and dimensioned to receive, mix, and discharge high volumes of proppant sand. In this embodiment, the static, impingement-type, mixing members (23) are formed by a series of rods or pipes (29) that horizontally traverse a drum (30) and are vertically distributed in a helical pattern (31) at an inter-rod distance (32) over the height of the drum (30). Three eyelets (33) attached to the top of the drum (30) provide supports for hanging the mixer below a free-fall discharge port of conventional proppant sand handling equipment.

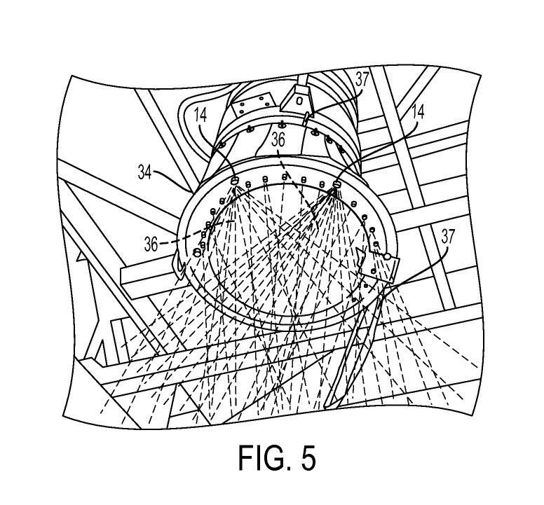

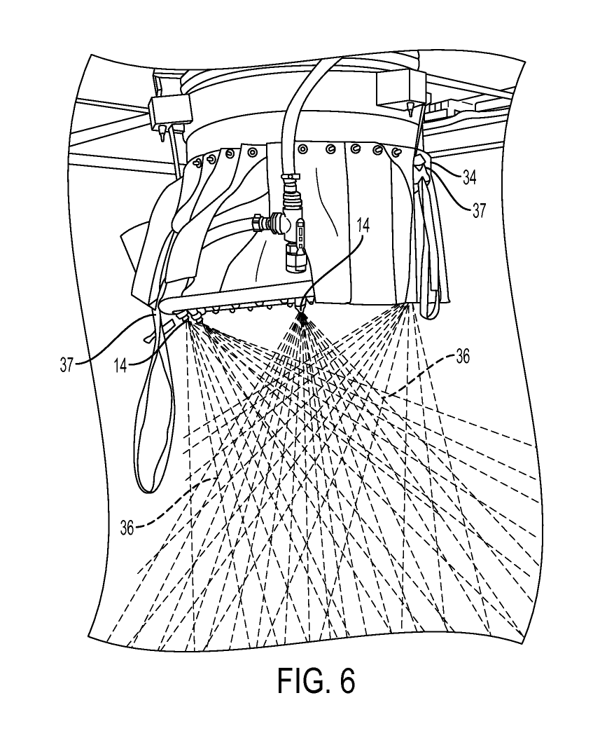

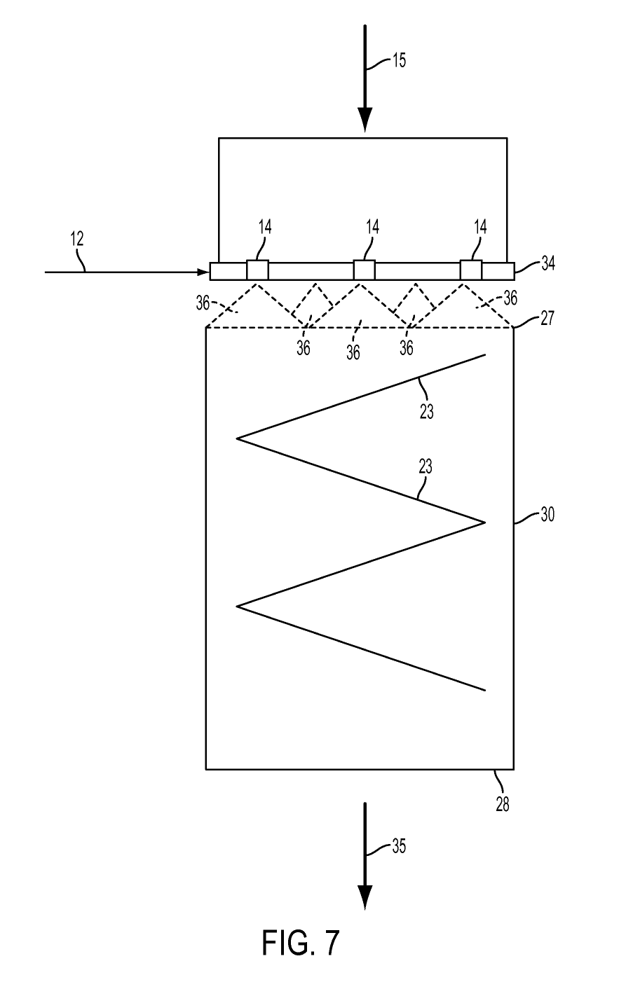

A spray assembly (34) is shown in FIGS. 5 and 6 that can be used in combination with the static mixer (13) of FIGS. 3 and 4 in a configuration like that of FIG. 7. More specifically, a spray assembly (34) is attached around the perimeter of a sand discharge port with a series of one or more, suitably 3-7, spray nozzles (14) that are substantially evenly distributed around the spray assembly (34). Each nozzle (14) is oriented radially inwardly and downwardly with overlapping spray pattern areas (36) so that sand introduced into the top inlet (27) is contacted with one or more spray streams of liquid treatment agent issuing through nozzles (14) at the top end of, or immediately before, the static mixer (13) located immediately below the spray assembly (34) to discharge a treated sand (35). Connectors or straps (37) on the spray assembly (34) are distributed to cooperate with eyehooks (33) on the static mixer for suspending the static mixer below the spray assembly.

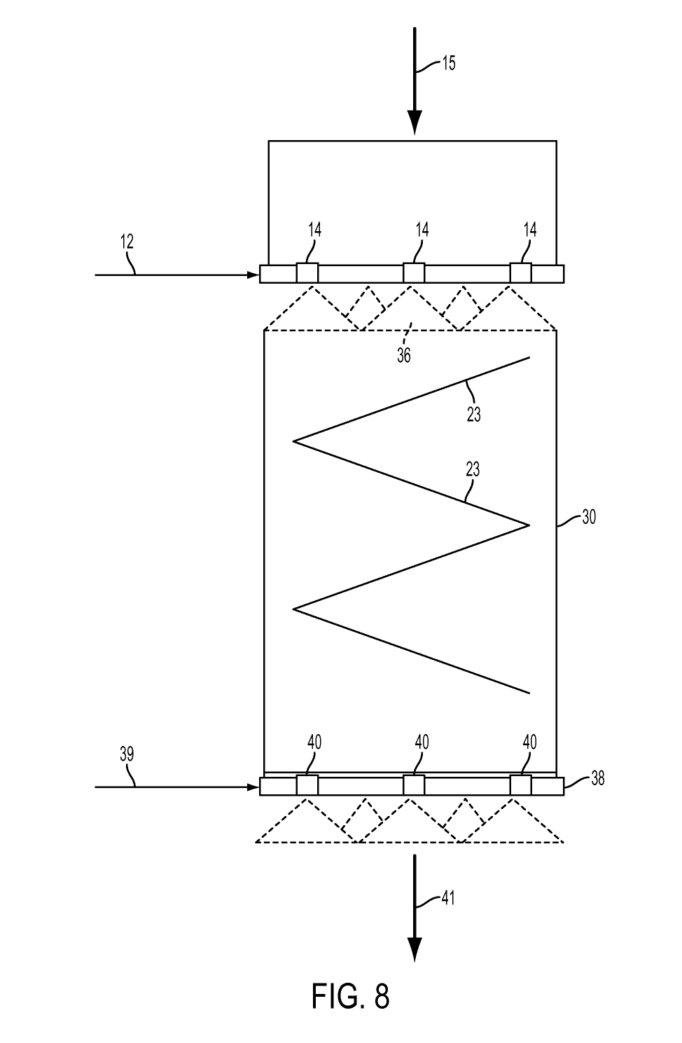

FIG. 8 illustrates an alternative version of the mixer that is shown in FIG. 7 but with the addition of a second spray assembly (38) connected to a second liquid treatment agent (39) that can be the same or different than liquid treatment agent (12). Exemplary second liquid treatment agents can include: the dust control agents introduced as the first liquid treatment agent (12) as well as the functional treatments that are described above. The second spray region can be used to add a second functionality to the coating or simply to help insure that more of the proppant's surface area is covered by the coating process. Second nozzles (40) are oriented to spray the second liquid treatment agent (39) downwardly as treated sand (41) is discharged.

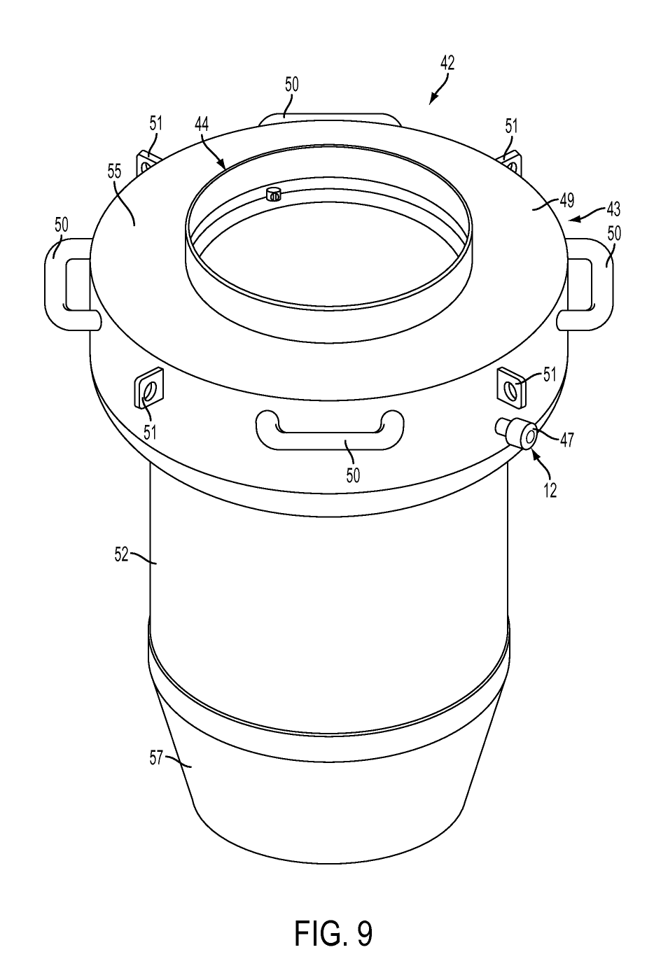

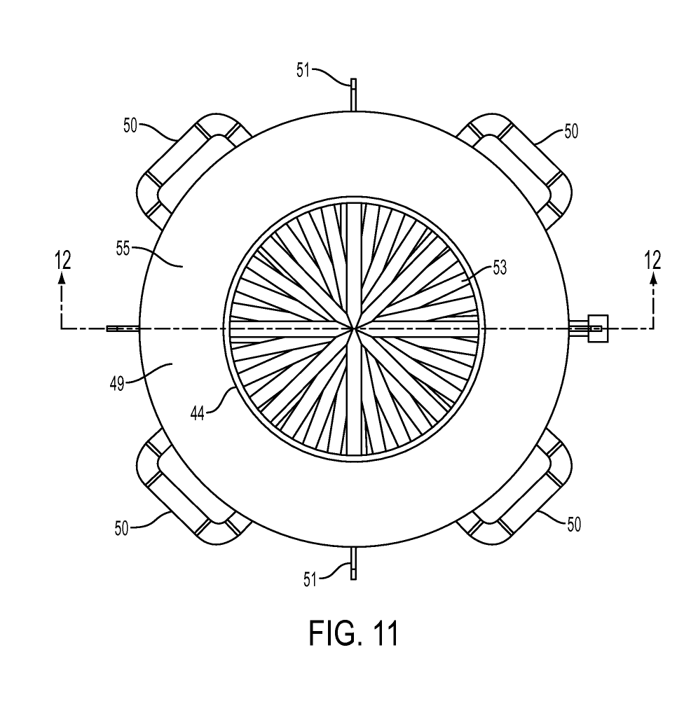

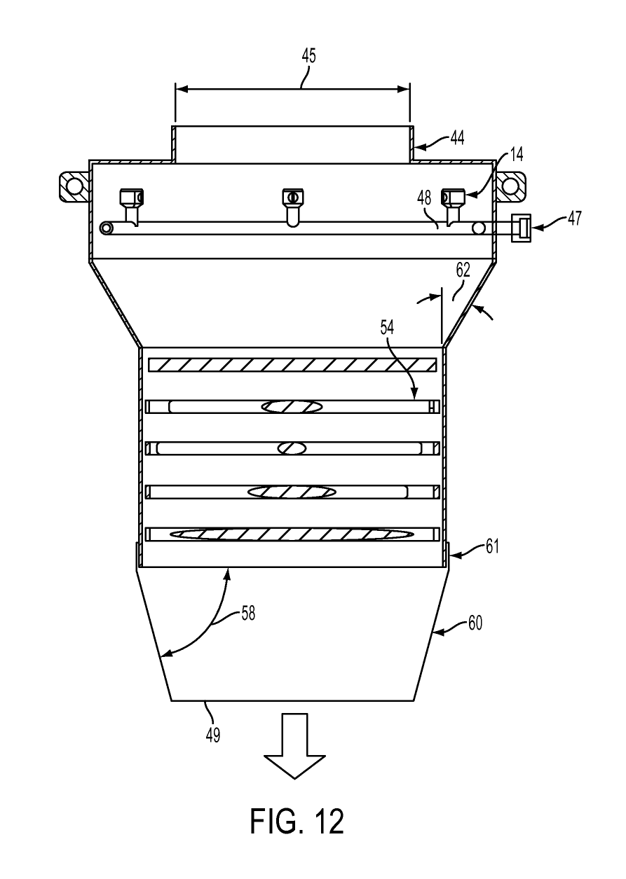

FIGS. 9-12 depict further alternatives for a contact device for a sprayed dust control liquid treatment agent that contacts the proppant solids on-the-fly while the solids are in a guided free fall under the effects of gravity. It is contemplated that the use of inline spray dispersion systems can be used with minor modifications of conventional pneumatic conveyance systems to provide dust control treatment as the proppant solids are transported to or from storage.

As shown in FIGS. 9-12, a contact mixer (42) is vertically oriented to allow proppant solids to fall therethrough. The top section (43) has a reinforcing vertical lip (44) about the intake opening (45) of a cover (55). The diameter of the top section (43) is greater than that of the diameter of the opening (45) to allow the nozzles (14) to disperse the dust control liquid treatment agent inwardly into a falling stream of proppants to be treated from a relatively safe perimeter position that is not impacted by the stream of falling solids and the abrasion associated therewith.

As shown, a supply connector (47) connects to a circular manifold (48) that is in fluid communication with nozzles (14) oriented inwardly toward the center of the device for the supply, under pressure, of liquid treatment agent to proppants as they fall through the opening (45). A horizontal upper surface (49) of the cover (55) extends inwardly toward the lip (44) to provide a partial upper enclosure of the contact zone that also reduce upwelling fugitive dust during the treatment process. An inward taper of the sidewalls below the nozzles (14) helps to guide solids from the sidewalls toward the middle mixing section.

Handles (50), such as 2-4 handles, and/or lifting lugs (51), such as 2-4 lugs, can be secured to the outside of the sidewall of the uppermost end (43) for handling and positioning the device.

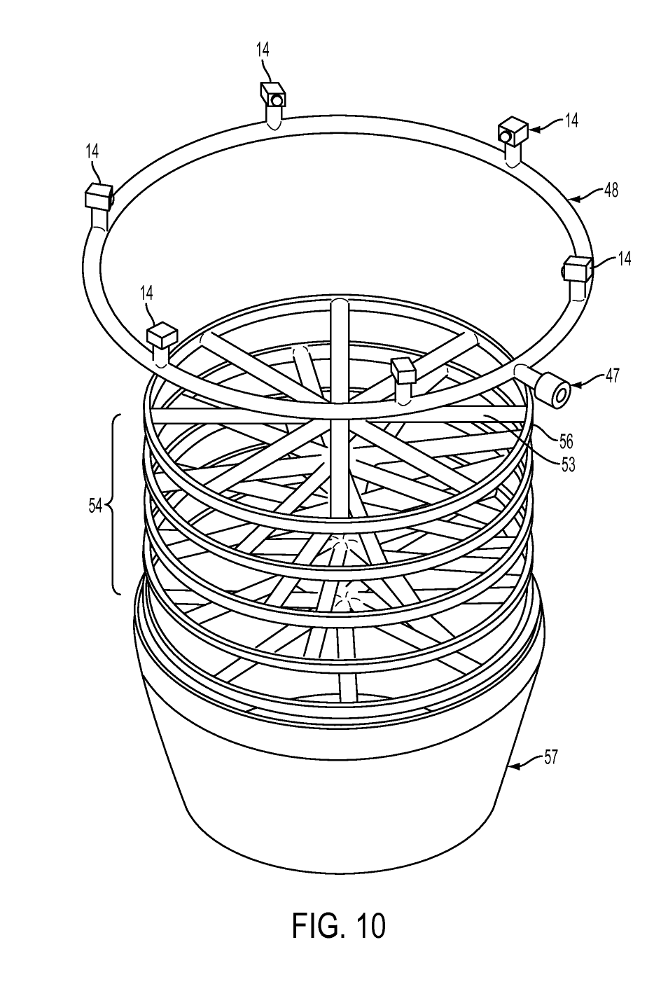

The middle section (52) of the contact mixer (42) can be cylindrical in external shape and include plurality of static mixing deflector members (53). As shown, the static mixing deflector members (53) can be disposed as a plurality of spoke members within an outer ring (56) as a modular, substantially planar, spoke-containing hoop unit (54). FIG. 10 shows the use of five such spoked hoop units (54), each having six deflector spoke members (55) that are evenly distributed around the interior of a ring (56) and that meet at substantially the geometric center of their respective hoop unit (54). The mixing deflector members (53) can be secured to the outer ring (56) by any method including welding, soldering, brazing and/or fasters. Each deflection hoop member (54) can be secured to the ring (56) by welding, brazing, soldering or similarly permanent and durable connection.

Each successive hoop unit (54) is then stacked vertically within middle portion (52) above the bottom section (57) and offset an appropriate angular amount relative to the preceding hoop unit (54) to provide a helical progression of deflector members (53) down the length of the middle portion (52) in the mixer (46). The lowest hoop unit (54) can rest on the top of the bottom section (57) but can be supported by a support flange or bracket (not shown) that is secured to the interior sidewall at the bottom (61) of the middle section (52).

The modular nature of this form of mixing device permits the degree and duration of mixing to be adjusted based on the number of mixing spokes found in each unit and the number of mixing modules that are used in the device.

The bottom section (57) of the mixer (46) can be in the form of a straight cylinder (i.e., about 180 degrees relative to the outer sides of the middle section (52)) but can exhibit an inwardly tapered frustoconical cross section (60) that is at an angle (58) that is within the range from about 150-175 degrees, or at an angle within the range of about 160-170 degrees. This tapering section helps to channel and settle the particulates at the outer perimeter of the treated proppant stream for discharge from the bottom opening (59). Similarly, the bottom of the top section (43) can exhibit an inward taper at an angle (62) that is within the range from about 15-45 degrees, or 25-35 degrees from vertical.

Accordingly, in some embodiments, a process for treating free-flowing, finely divided proppant solids is provided. In some embodiments, the process comprises contacting the solids less than five seconds with a liquid treatment agent with an amount of the liquid treatment agent that substantially retains free-flowing characteristics of the treated solids. The liquid treatment agent can be any agent described herein and contain one or more of the compositions described herein. In some embodiments, the solids are contacted with the liquid treatment agent more than once and each contacting step is for less than five seconds. The time period for contact can also be any time period as described herein.

The processes described herein are suitable for applying coatings or agents to various finely divided proppant solids. Examples include, but are not limited to, uncoated sand, sand with a cured or partially cured coating, bauxite, ceramic, coated bauxite, or ceramic. In some embodiments, the finely divided proppant solids are uncoated sand or resin-coated sand.

In some embodiments, the process comprises spraying the liquid treatment agent onto the proppant solids while the solids are in free fall, guided free fall, or during pneumatic transport. Other embodiments are described herein can also be part of the process. The solids can also be sprayed substantially simultaneously from more than one direction.

As described herein, the processes described herein can be used to apply a dust reduction coating. The liquid treatment agent can also be effective or used to coat the solids with any one or more of: a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, and/or a coating comprising an ion exchange resin that removes anions and/or halogens, or any combination thereof. Examples of such coatings are described herein.

In some embodiments, a process for producing free-flowing, finely divided proppant solids with reduced dust properties is provided. In some embodiments, the process comprise contacting the solids for a period of time as described herein with a dust reducing liquid treatment agent with an amount of the dust reducing liquid treatment agent that substantially retains free-flowing characteristics of the treated solids and reduces the dust produced by the solids. In some embodiments, the dust produced by free-flowing, finely divided proppant solids with reduced dust properties is less than dust produced by solids not contacted with the dust reducing liquid treatment agent. In some embodiments, the dust reducing liquid treatment agent is effective to coat the solids with a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, and/or a coating comprising an ion exchange resin that removes anions and/or halogens. That is, in some embodiments, the coating can have more than one function. In some embodiments, the dust reducing treatment agent comprises a polysaccharide solution. In some embodiments, the dust reducing treatment agent comprises a C₆-C₁₆ alkoxylated alcohol. In some embodiments, the dust reducing treatment agent comprises at least one acrylic polymer. In some embodiments, the dust reducing treatment agent comprises an acrylic copolymer. In some embodiments, the dust reducing treatment agent comprises a mixture of at least one C₆-C₁₆ alkoxylated alcohol and at least one acrylic polymer. In some embodiments, the amount of the dust reducing treatment agent that is applied to the solids is an amount of less than 1 wt % per weight based on the weight of said proppant solids. In some embodiments, the amount is an amount of less than 0.5 wt %. In some embodiments, the amount is an amount of less than 0.35 wt %. In some embodiments. In some embodiments, the amount is an amount of less than 0.25 wt %.

In some embodiments, the dust reducing treatment agent comprises an emulsion of ethoxylated, propoxylated C₆-C₁₂ alcohols, ethoxylated, propoxylated C₁₀-C₁₆ alcohols, acrylic polymers, and water. In some embodiments, the dust reducing treatment agent comprises a surfactant. In some embodiments, the dust reducing treatment agent comprises less than 0.1% aqueous ammonia. In some embodiments, the dust reducing treatment agent comprises less than 0.05% free (e.g. residual) monomers. In some embodiments, the dust treatment agent comprises about 15% to about 30%, about 17 to about 28%, or about 20% to about 25% of ethoxylated, propoxylated C₆-C₁₂ alcohols. In some embodiments, the dust treatment agent comprises about 5% to about 20%, about 8 to about 18%, or about 10% to about 15% of ethoxylated, propoxylated C₁₀-C₁₆ alcohols. In some embodiments, the dust reducing reagent comprises about 20% to about 25% of ethoxylated, propoxylated C₆-C₁₂ alcohols, about 10% to about 15% of ethoxylated, propoxylated C₁₀-C₁₆ alcohols, about 5% to about 10% acrylic polymers, less than 0.1% ammonia, less than 0.05% free monomers. In some embodiments, the dust reducing reagent comprises about 20% to about 25% of ethoxylated, propoxylated C₆-C₁₂ alcohols, about 10% to about 15% of ethoxylated, propoxylated C₁₀-C₁₆ alcohols, about 5% to about 10% acrylic polymers, less than 0.1% ammonia, less than 0.05% free monomers with the remaining being water.

In some embodiments, a process for coating a free-flowing proppant is provided. In some embodiments, the process comprises contacting the proppant for a period of time as described herein with a liquid treatment agent with an amount of the liquid treatment agent that substantially retains free-flowing characteristics of the proppant to produce coated free-flowing proppant, wherein the coating is a dust reducing coating, a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, and/or a coating comprising an ion exchange resin that removes anions and/or halogens, or any combination thereof. In some embodiments, the coating is a dust reducing coating. In some embodiments, the coating is a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, or a coating comprising an ion exchange resin that removes anions and/or halogens, or any combination thereof.

Coated free-flowing proppants comprising a dried and/or cured coating that comprises less than about 3 wt % of a liquid treatment agent are also provided. In some embodiments, the coated, free-flowing proppant exhibits reduced fugitive dust generation as compared to the uncoated proppant. In some embodiments, the coated, free-flowing proppant comprises 0.0009-0.5 wt % of the coating. In some embodiments, the coated, free-flowing proppant comprises 0.001-0.35 wt % of the coating. In some embodiments, the coating comprises one or more of: monosaccharides or polysaccharides, surfactants, alkoxylated alcohols, acrylic polymers, methacrylic polymers, copolymers of acrylic acid and/or methacrylic acid, methacrylates and copolymers thereof, polyvinyl acetates, vinyl acrylic copolymers, polybutadiene, low molecular weight mineral oils, acrylamide polymers, lignosulfonates, water-dispersible natural gums, water-dispersible pectins, water-dispersible starch derivatives, water-dispersible cellulose derivatives, or any mixture thereof.

In some embodiments, the coating comprises one or more monosaccharides or polysaccharides. In some embodiments, the coating comprises one or more alkoxylated alcohols. In some embodiments, the coating comprises at least one C₆-C₁₂ alkoxylated alcohol and at least one C₁₀-C₁₆ alkoxylated alcohol. In some embodiments, the coating comprises one or more acrylic polymers. In some embodiments, the coating comprises at least one C₆-C₁₂ alkoxylated alcohol, at least one C₁₀-C₁₆ alkoxylated alcohols, and at least one acrylic polymer. In some embodiments, the coating comprises one or more methacrylic polymers, one or more copolymers of acrylic acid and/or methacrylic acid, and one or more of methacrylates. In some embodiments, the coating is a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, or a coating comprising an ion exchange resin that removes anions and/or halogens. In some embodiments, the coating further comprises a sulfide scavenger or scale inhibitor.

Various liquid treatment agents are described herein. The liquid treatment agents can be applied to the solids according to any of the various embodiments described herein. The liquid treatment agents can be applied simultaneously or consecutively. Additionally, the processes described herein can be used to add multiple layers or coatings to the solids. The liquid treatment agents can also be applied singularly or in any combination with one another. The process is not limited to applying any one coating, unless explicitly stated to the contrary.

The liquid treatment agent that can be used in the methods described herein can be an aqueous solution or emulsion. In some embodiments, the liquid treatment agent can be used to reduce dust produced by the solids. This can be referred to as “fugitive dust control.” In some embodiments, a liquid treatment agent for controlling dust can be, for example, an aqueous solution or emulsion comprising one or more polysaccharides, surfactants and alkoxylated alcohols, acrylic polymers, methacrylic polymers and copolymers of acrylic acid and/or methacrylic acid, polyvinyl acetates, vinyl acrylic copolymers, methacrylates (see U.S. Pat. No. 4,594,268) and copolymers with methacrylates, polybutadiene, low molecular weight mineral oils, and mixtures thereof. The use of aqueous solutions permit the liquid treatment agent to be purchased as a concentrate and then diluted to a working concentration when needed or when there is access to a supply of dilution water. The use of water-based dispersions also avoids the need to handle another hydrocarbon material at the wellsite.

Suitable monosaccharides and polysaccharides include starches, sugars and sugar-based materials. Examples of such materials include, but are not limited to, molasses, glycerol, hydrol, black-strap, residual syrups, mother liquors, bagasse, sorgo molasses, wood molasses, or corn molasses and/or beet or cane sugar juices formed during the raw preparation or refining of sugar. For example, see the fertilizer treatment described in WO 2013/029140 made with (a) raffinate and (b) sugar-containing solution. The raffinate (a) is an aqueous solution effluent (for instance syrup or liquor) from fermentation processes (residuary or not). Raffinate (a) is an aqueous solution comprising at least citric acid, inorganic matter (such as minerals), proteic matter and sugar matter. The sugar includes carbohydrate selected from fructose, dextrose, maltose and/or polyol selected from arabitol, erythritol, or mixtures thereof. See also U.S. Pat. Nos. 6,790,245 and 7,157,021.

Non-limiting examples of surfactants and alkoxylated alcohols that can be used include, but are not limited to, C₁₀-C₁₄ alpha-olefin sulfonates, C₁₀-C₁₆ alcohol sulfates, C₂-C₁₆ alcohol ether sulfates, C₂-C₁₆ alpha sulfo esters, highly branched anionic surfactants, nonionic surfactants that are block copolymers of molecular weight less than 600 and derived from ethylene oxide/propylene oxide or other epoxide, nonionic surfactants that are C₈-C₁₆ branched alcohols that have been ethoxylated with four to ten moles of ethylene oxide per mole alcohol, and mixtures thereof. For example, see the coal dust treatment described in CA Patent No. 2,163,972 and U.S. Pat. No. 4,592,931. See also U.S. Pat. Nos. 6,372,842; 5,194,174; 4,417,992 and 4,801,635. Other examples include those described in EP01234106A2; U.S. Pat. No. 3,900,611; U.S. Pat. No. 3,763,072; WO 2005/121272 and U.S. Patent Application Publication No. 2007/073590. Any overlap in molecular length in the above ranges is due to the realities of commercial production and separation and would be so recognized by those in this technology.

A variety of water soluble or water-dispersed polymers or polymer emulsions can also be a part of the liquid treatment agent. Examples include, but are not limited to, acrylic polymers and copolymers, methacrylic polymers and copolymers of acrylic acid and/or methacrylic acid. Examples of alkoxylated alcohols that can be used include, but are not limited to, acrylic acid copolymers of acrylic acid and one or more of unsaturated aliphatic carboxylic acids such as 2-chloroacrylic acid, 2-bromoacrylic acid, maleic acid, fumaric acid, itaconic acid, methacrylic acid, mesaconic acid or the like or unsaturated compounds copolymerizable with acrylic acid, for example, acrylonitrile, methyl acrylate, methyl methacrylate, vinyl acetate, vinyl propionate, methyl itaconate, styrene, 2-hydroxylethyl methacrylate, and the like.

In some embodiments, the polyacrylic acid or acrylic acid copolymer has a weight average molecular weight of from about 5,000 to about 30 million or from about 1 million to about 5 million. In some embodiments, the amount of acrylic polymer present in the mixture with the polybasic acid is about 2 to about 50, about 3 to about 10, or about 4, parts by weight per weight part of polybasic acid. See, U.S. Pat. No. 4,592,931 the disclosure of which is hereby incorporated by reference.

Polyvinyl acetate and vinyl acrylic solutions and emulsions can also be used in the liquid treatment agent. For example, water-dispersible acrylic and vinyl polymers are suitable, include but are not limited to the homo-, co-, and ter-polymers of acrylic acid, vinyl alcohol, vinyl acetate, dimethyl diacrylyl ammonium chloride (DMDAAC), acrylaminyl propyl sulfonate (AMPS) and the like, and combinations thereof.

Acrylamide polymers can also be used in the liquid treatment agent. Examples of acrylamide polymers include, but are not limited to, a polyacrylamide copolymer in an amount within the range from about 0.5 to about 20 wt % of the resulting mixture. In some embodiments, the acrylamide is added in an amount from about 1 to about 2 wt %. Examples of suitable acrylamides include, but are not limited to, anionic charged polyacrylamides or polyacrylamide polyacrylate copolymers with an average molecular weight from 3 million to 25 million g/mol and a charge density from 10% to 60%. Non-limiting examples of commercial acrylamide products include: AN934XD from SNF, Inc., AF306 from Hychem, Inc., and Magnafloc 336 from CIBA.

The polyacrylamide can be used alone or in combination with a starch that has been modified for enhanced solubility in cold water. See U.S. Pat. No. 5,242,248 (polyacrylamide treatment for horse arenas) and Published U.S. Patent Application Publication No. 20130184381, the disclosures of which are hereby incorporated by reference.

Lignosulfonates can also be used as the liquid treatment agent or as a component of the liquid treatment agent. Examples include, but are not limited to, lignin sulfonate salts such as ammonium lignin sulfonate, and alkali metal and alkaline earth metal salts of lignosulfonic acid, such as sodium lignin sulfonate, calcium lignin sulfonate and the like, and combinations thereof. In some embodiments, ammonium lignin sulfonate can be used. Without wishing to be bound by any particular theory, ammonium lignin sulfonate can be used in order to avoid the addition of inorganic materials such as calcium and sodium, particularly sodium.

The liquid treatment agent can also include one or more water-dispersible natural gums, water-dispersible pectins, water-dispersible starch derivatives, or water-dispersible cellulose derivatives. Examples of natural gums include: terrestrial plant exudates including, but not limited to, gum arabic (acacia), gum tragacanth, gum karaya, and the like; terrestrial plant seed mucilages, including but not limited, to psyllium seed gum, flax seed gum, guar gum, locust bean gum, tamarind kernel powder, okra, and the like; derived marine plant mucilages, including but not limited to, algin, alginates, carrageenan, agar, furcellaran, and the like; other terrestrial plant extracts including but not limited to arabinogalactan, pectin, and the like; microbial fermentation products including but not limited to xanthan, dextran, scleroglucan, and the like. Cellulose derivatives include chemical derivatives of cellulose, including but not limited to, alkyl, carboxyalkyl, hydroxyalkyl and combination ethers, and the sulfonate and phosphate esters.

In some embodiments, the guar gum is a solution whose viscosity can be adjusted to accommodate variations in the treated solids. For example, the viscosity of a guar gum solution can be adjusted by treatment with gamma radiation to achieve a viscosity of about 40 to about 140 cps at 1% concentration at application temperature. Guar gum (such as that sold by Rantec, Inc. under the trade names Super Tack, C7000, J3000, and HVX); carboxymethyl guar gum (such as CM Guar sold by Maharashtra Traders); carboxymethyl cassia seed powder (such as CM Cassia sold by Maharashtra Traders); carboxymethyl cellulose (such as FinnFix300 sold by Noviant); starch (corn, maize, potato, tapioca, and wet milled/spray dried starch such as GW8900 sold by KTM Industries); starches pre-treated with crosslinking agents such as epiclorohydrin and phosphorus oxychloride; Carboxymethyl starch (0.2 to 0.3 degree of substitution (DS), such as AquaBloc, KogumHS, RT3063 and RT3064 sold by Process Products N.W.); hydroxypropyl guar gum; hydroxyethyl guar gum; carboxymethyl-hydroxypropyl guar gum; ethyl starch; oxidized starch; and hydroxyethyl cellulose. Other examples of polymers include Cassia seed powder, psyllium husk powder, xanthan gum, any cereal grain, annual or perennial dicot seed derived polysaccharide (sesbania, locust, bean gum, flax seed, and gum karaya).

In some embodiments, prior to the addition of guar gum, the water for the treatment agent formulation can be treated with a crosslinking agent made with a blend of one part glyoxal and two parts zirconium lactate (e.g., the DuPont product sold under the brand name TYZOR 217) at a rate of 30 to 50 parts crosslinking agent per 100 parts of polymer. For example, to 15 gallons of water (125.1-lb) a dose of 1.75-lb of guar gum is to be added; prior to the polymer addition a dose of 0.70-lb of crosslinking agent (40% of 1.75-lb of polymer) is added. The guar gum polymer can, in some embodiments, be added to the water at a rate of 0.70% to 1.4% by weight. A plasticizer, glycerin, can also be added at a rate of 0.5 to 5% by weight of the guar gum solution.

Water-dispersible starch derivatives include, but are not limited to, alkyl, carboxyalkyl, hydroxyalkyl and combination ethers of starch, phosphate or sulfonate esters of starch and the like which are prepared by various chemical or enzymatic reaction processes.

Tables 1 and 2 are non-limiting exemplary lists of liquid, dust suppressing, chemical liquid treatment agents by category and commercial product name that can be used to treat proppant solids for fugitive dust control according to the processes and methods described herein.

TABLE 1

| SUPPRESSANT | PRODUCT | MANUFACTURER OR |
|---|---|---|
| CATEGORY | NAME | PRIMARY DISTRIBUTOR |
| Molassas/Sugar | Dust Down | Amalgamated Sugar Co. |
| Beet | | |
| Tall Oil | Dust Control E | Pacific Chemicals, Inc./ |
| Emulsion | | Lyman Dust Control |
| | Dustrol EX | Pacific Chemicals, Inc/Lyman |
| | | Dust Control |
| | Road Oyl | Soil Stabilization Products Co., Inc. |
| Vegetable Oils | Soapstock | Kansas Soybean Association |
| | | Indiana Soybean Association |
| | Dust Control | Greenland Corp. |
| | Agent SS | |
| Enzymes | Bio Cat 300-1 | Soil Stabilization Products Co., Inc. |
| | EMCSQUARED | Soil Stabilization Products Co., Inc. |
| | Perma-Zyme 11X | The Charbon Group, Inc. |
| | UBIX No. 0010 | Enzymes Plus, Div of Anderson |
| | | Affiliates |
| Ionic | Road Bond EN-1 | C.S.S. Technology, Inc. |
| | Terrastone | Moorhead Group |
| Sulfonated Oils | CBR Plus | CBR Plus, Inc. (Canada) |
| | Condor SS | Earth Sciences Products Corp. |
| | SA-44 System | Dallas Roadway Products, Inc. |
| | Settler | Mantex |
| | TerraBond Clay | Fluid Sciences, LLC |
| | Stabilizer | |
| Polyvinyl | Aerospray 70A | Cytec Industries |
| Acetate | Soil Master WR | Enviromental Soil Systems, Inc. |
| Vinyl Acrylic | Earthbound L | Earth Chem Inc. |
| | ECO-110 | Chem-crete |
| | PolyPavement | PolyPavement Company |
| | Liquid Dust | Enviroseal Corp. |
| | Control | |
| | Marloc | Reclamare Co. |
| | Soiloc-D | Hercules Soiloc |
| | Soil Seal | Soil Stabilization Products Co., Inc. |
| | Soil Sement | Midwestern Industrial Supply, Inc. |
| | TerraBond | Fluid Sciences, LLC |
| | PolySeal | |
| Combination of | Top Shield | Base Seal International, Inc. |
| Polymers | | |

TABLE 2
Polymers
TerraLOC—polyvinyl alcohol from MonoSol, LLC, Portage IN 46368
Tracer Tackifier—copolymer of sodium acrylate and acrylamide with
pre-gelatinized starch from Reinco Inc., Plainfield, NJ 07061
DirtGlue—acrylate ester polymer emulsion and organosilicon
waterproofing agent (US 2012020755) from TerraFirmer Corporation,
Amesbury, Massachusetts 01913
Soil Sement—emulsion of acrylic and vinyl acetate polymer plus a
resin-modified emulsion made with a mixture of pitch and rosin (US
2013019128) from Midwest Industrial Supply, Akron, Ohio
Enviroseal LDC—inorganic acrylic copolymers from Enviroseal
Corporation, Port St. Lucie, Florida 34952
Envirotac II—acrylic copolymers from Environmental Products &
Applications, La Quinta, California 92253
DustShield—acrylic styrene emulsion polymer from Soil-Loc, Inc.,
Scottsdale, Arizona 85255
SoilShield-LS—Poly vinyl acrylic copolymer from Soil-Loc, Inc.,
Scottsdale, Arizona 85255
Marloc—copolymer emulsion from Rantec Corp., Ranchester, WY
82839
SOILOC-MQ—liquid blend of acrylic resins from Hercules
Environmental, Inc., Doraville, GA 30340
Polytac—acrylic co-polymer from DustPro, Inc., Phoenix, AZ 85034
Soiltac ®—synthetic copolymer emulsion from Soilworks, LLC.,
Chandler, AZ 85286
Lignin Sulfonates
Lignosite 458—from Georgia-Pacific Chemicals LLC, Atlanta, GA
LS-50 from Prince Minerals, New York, NY 10036
Other Chemical Suppressants
EK-35—high viscosity synthetic iso-alkane from Midwest Industrial
Supply, Inc., Canton, OH
EnviroKleen—sodium salt of a secondary alkane sulphonate and D-
limonene from Milestone Chemicals Australia Pty Ltd., West Heidelberg,
Vic. 3081, Australia
Earthzyme—multi-enzyme product from Cypher International Ltd.,
Winnepeg, MB Canada RG3 0J8
Diamond Doctor—severely hydrotreated, hydorcracked,
hydroisomerized, high viscosity synthetic iso-alkane (CAS 178603-64-0)
from Midwest Industrial Supply, Inc., Canton, OH
DUSTRACT—mixture of diethylene glycol, ethyl alcohol and sodium
dioctyl succinate from Midwest Industrial Supply, Inc., Canton, OH
DustFloc—blend of natural and organic polysaccharides from Apex
Resources, Inc., Louisville, KY 40228
Roadbond EN1— sulphonates and surfactants from C.S.S. Technology,
Inc., Tolar, TX 76476
TERGITOL ™ NP- or NP-9—nonionic surfactants from Dow
Chemical
PAVECRYL ™ SUPPRESS—vinyl/acrylic emulsion from Dow
Chemical
Other Emulsions
ArenaPro—natural soy-lecithin blend from Dustkill LLC, Columbus, IN
47203
Road Oyl Resin Modified Emulsion—a pine rosin and pitch emulsion
alleged to be made in accordance with US Patent No. 4,822,425; from
Midwest Industrial Supply, Inc., Canton, OH

The products described herein can be contacted with the solids as described herein. The processes are not limited to the specific examples. Other liquid, dust suppression, liquid treatment agents that are typically commercially available and described as useful for controlling unpaved road dust, dust from storage piles, and similar structures can also be used. Such agents can be aqueous or solvent-based, but are not just water or a volatile solvent. That is, in some embodiments, a liquid treatment agent is not water or a volatile solvent not containing any other components. A listing of such materials has been published by the City of Albuquerque and can be found at goo“dot”gl/wlehmI.

In some embodiments, the liquid treatment agent can be in the form of thin coatings that can cure by contact with ambient water or moisture, e.g., an alkyd that can cure on exposure to moisture.

In some embodiments, the liquid treatment agent comprises a light mineral oil which can be contacted with the proppant solids in the form of a light oil or in an aqueous form with a surfactant. Mineral oils that can be used as/in the liquid treatment agent include, but are not limited to, mineral oils characterized by a pour point of from about 30° F. to about 120° F., a viscosity from about 50 SSU to about 350 SSU at 100° F., a distillation temperature above about 500° F., a distillation end point below about 1000° F., a distillation residue of not more than about 15%, and an aromatic content of not more than about 60%.

In some embodiments, mineral oils are characterized by a pour point of from about 35° F. to about 100° F., a viscosity from about 100 SSU to about 310 SSU at 100° F., a 10% distillation temperature from about 500° F. to about 700° F., a distillation end point below about 900° F., a distillation residue of not more than about 15%, and an aromatic content of not more than about 50%.

The mode or modes by which the liquid treatment agent according to the methods disclosed herein reduces fugitive dust is not, as yet, fully understood. While not wishing to be bound by any particular theory, it may be that the applied liquid treatment agent provides a sufficiently adhesive surface that generated fugitive dust merely sticks to the outer surface of a treated solid. It may also be that the treated surface acts as a wetted surface of reduced friction that allows impacts to slide off rather than impart a structural shock impact to the proppant. A further possibility is that the small amount of applied dust control liquid treatment agent acts as an adhesive and that fugitive dust captured on the surface of the treated proppant acts as an impact modifier to cushion impacts and friction that might otherwise generate fugitive dust from the proppant surface. It may also be that when the chosen polymer is applied to some substantial part of the exposed surface area that the polymer acts as an impact modifier to cushion the impact of the grain-to-metal or grain-to-grain contacts. It may also be that, if the treatment process does not fully cover the exposed surface area, that the collision of an uncoated grain with a partially-coated grain still can minimize the generation of dust/broken particles. The exact reason that the processes described herein can be used to reduce dust is not necessarily significant, but rather the result that is achieved is.

The processes described herein can also be used to apply other coatings to proppants. Such other coatings can provide the proppants with additional, functional properties at the same time as the dust control treatment or an independent treatment step. Such other coatings can include the following. The processes can also be used to provide a coating that does not result in fugitive dust control.

Hydrophobic Coatings.

Water barriers are useful to prevent reaction or dissolution of proppant under acidic or basic conditions downhole. Chemical reactions of proppant are known to cause reductions in crush resistance, and potential scale formation through diagenesis, i.e., dissolution of the proppant and re-precipitation with dissolved minerals in the formation water.

A water resistant coating can be formed by contacting the proppant solids with one or more organofunctional alkoxy silanes to develop a hydrophobic surface. Examples of organofunctional alkoxy silanes include, but are not limited to, waterborne or anhydrous alkyl or aryl silanes. Triethoxy [(CH₃CH₂O)₃SiR], or trimethoxy [(CH₃O)₃SiR] where R represents a substituted or unsubstituted alkyl or substituted or unsubstituted aryl moiety, silanes and chlorosilanes could be used as well if a lower reaction temperature and higher speed of reaction are necessary. It should be noted that HCl can be generated as a byproduct of the treatment process, which can cause issues with corrosion. Therefore, in some embodiments, corrosion-resistant treatment heads and handling equipment immediately after the chlorosilane treatment can be used.

In some embodiments, if a hydrophobic and oleophobic surface is required, treatment of the proppant with a fluoroalkyl silane is performed.

If a thicker crosslinked, polymeric coating is needed for enhanced durability and hydrophobicity, a polymer can be applied after the silane treatment. In such a treatment, the silanes can include, but are not limited to, a triethoxy [(CH₃CH₂O)₃SiR], or trimethoxy [(CH₃O)₃SiR] silane, where the R can include a functional group that could either react with crosslinkable polymers after they are applied on the surface of the proppant, or can be chemically compatible with the polymer for van der Waals force of adhesion of the polymer. In some embodiments, the R Groups for the silanes include, but are not limited to:
amines (for preparation or polyurethanes, polyureas, polyamides, polyimides or epoxies Amines can also be used for polysulfones);
isocyanates (for polyurethane, polyurea coatings);
vinyl (for reaction with polybutadiene, polystyrenebutadiene, other addition type olefinic polymers, or reaction with residual vinyl groups in any copolymer blends used as coatings);
epoxides (for reaction with epoxies);
methacrylate or ureido groups (for polyacrylates); and
phenyl groups (for use with aromatic-containing polymers such as the polyaryletherketones (PAEKs) and their composites such as polyetherketoneketone (PEKK)/50:50 terephthallic:isothallic/amorphous polyetherketoneetherketoneketone (PEKEKK), polyethersulfone (PES), polyphenylsulfone (PPSU), polyetherimine (PEI), or poly(p-phenylene oxide) (PPO)).

The thicker, crosslinked, polymeric coatings can be prepared by a first step of application of silanes, followed by a second step of flash coating with the polymer, prepolymers, or monomers. As used herein, the phrase “flash coating” refers to the process of applying the agent according to a process described herein. In some embodiments, catalysts can be used for inducing reactions at typical operating temperatures of the flash coating process, i.e. room temperature to 85° C. In some embodiments, methoxysilanes tend to react faster than ethoxy silanes, so methoxysilanes can be used for fast, flash-type coatings. If speed of reaction of the silane treatment is a limiting factor for proper coating, chlorosilanes can be used as substitutes for methoxy or ethoxysilanes. In some embodiments, corrosion resistant materials are used in the application process.

In some embodiments, methods for forming flash coatings of high temperature aromatic polymers use a solvent-based slurry or fully dissolved solution. Suitable solvents include, but are not limited to, N-methylpyrrolidone (NMP), dimethylformamide (DMF), and dimethylsulfoxide (DMSO). If excess solvents remain after application, they can be removed via a drying step prior to transfer into containers for shipment.

Scale Inhibition.

Several polymeric substances can be used on proppants to inhibit scale formation, including phosphino-polycarboxylates, polyacrylates, poly vinyl sulphonic acids, and sulphonated polyacrylate co-polymers, or any combination thereof. In the past, these polymers had to be injected into the formation where they would then disperse to be effective. See U.S. Pat. No. 5,092,404. Such injections often lead to a substantial volume of the inhibitor being produced back out of the well early in the production cycle. By applying them directly to the proppant as described herein, the coated proppants can provide a targeted, positionable, anti-scale treatment on the relatively large surface area of the proppants in fractured strata. With a large portion of the active surface area treated, the effective surface area where scale can form is reduced as well as prevent scale formation in the spaces between proppant particles (i.e., pores) where scale deposits can have a large negative impact on proppant conductivity.

Suitable scale inhibitors include, but are not limited to, carboxylates and acrylates. These inhibitors can be applied to the surface of a proppant in a similar manner to those other functional coatings described above. Also suitable are fumaric acid (CAS 110-17-8), Diethylene Glycol (CAS 111-46-6), phosphorous acid (CAS 13598-36-2), trisodium 2,2′({2-[(carboxylatomethyl)amino]ethyl}imino)diacetate (CAS 19019-43-3), sodium glycolate (CAS 2836-32-0), glycine (CAS 38011-25-5), trisodium nitrilotriacetate (CAS 5064-31-3), 1,2-propylene glycol (CAS 57-55-6), methoxyacetic acid (CAS 625-45-6), methylphosphonic acid (CAS 6419-19-8), polyphosphoric acids (CAS 68131-71-5), alkylbenzene (CAS 68648-87-3), phosphino-carboxylic acid (CAS 71050-62-9), trisodium ortho phosphate CAS 7601-54-9), and sodium polyacrylate (CAS 9003-04-7), or any combination thereof.

If additional adhesion to the proppant surface is needed due to too high of a solubility of the scale-inhibiting polymer in the production fluid, amines or ureidosilanes can be used as tethering agents for the acrylates and carboxylates. Full chemical bonding can also be achieved by adding a vinyl silane, and also retaining some vinyl functionality in the carboxylates, acrylates, and polyvinylphosphonic or polyvinylsulfonic acids. Peroxides can be used to initiate coupling of the vinyl silane with the vinyl polymer treatment, via addition of the peroxide in a subsequent treatment, and applying it to a heated substrate. In some embodiments, additives can be mixed with inert polymers to be sprayed to impart scale reduction functionality to the coatings. They could also be imbedded in water soluble polymers to allow timed release of the scale additives. The release time of the additives from the polymeric coating can be adjusted by modifying the swell rates of the polymer via adjustments to the crosslink density or density of concentrations of hydrophilic moieties on the polymer backbones.

Friction Reduction.

Currently, when those in the industry refer to “friction reduction” they are talking about the friction pressure generated when moving the frac fluid down the well, typically through tubular conduits to the formation to be treated. Of the mechanisms for friction reduction, the most accepted is thought to involve a reduction in turbulent flow due to the presence of stretched oligomers or high molecular weight polymers that extend into the fluid and disrupt the formation of turbulent eddies in the flowing fluid, often along the walls of a conduit.

Proppant treatment for reduced friction can take the form of a released, high molecular weight polymer that can help with fugitive dust control aboveground but which releases from the proppant into the frac fluid where it serves a second function as a turbulence reducer. Therefore, one can create a proppant that has fugitive dust control and reduced friction properties. In some embodiments, these properties can be imparted onto the solids with the same treatment agent.

In some embodiments, a direct coating of the proppant with one or more releasable or dissolvable polymers can deliver the turbulence-reducing agents for the well via a surface on the proppant. The coating can be designed to release the turbulence-reducing agents immediately or after some time delay. If delayed, such a coating can help reduce the volume of turbulence-reducing polymers in the frac fluid and avoid the associated deposits and loss of conductivity that can accompany such excess quantities. Once the proppant is placed in the fracture, the delayed dissolution or release of the polymeric turbulence-reducing coating on the proppant occurs in-situ for enhanced control and reduced opportunities for unintended deposits and accumulations of polymeric agents.

The turbulence-reducing coatings can be designed by those in this art for immediate release via use of water soluble polymers, or for timed release via tailoring of the water soluble polymer for delayed swelling. Materials that can be used for friction-reducing coatings include caprylic alcohol caprylic alcohol (CAS 111-87-5), polyacrylamide (CAS 25085-02-3), copolymer of acrylamide and sodium acrylate (CAS 25987-30-8), acrylamide/ammonium acrylate copolymer (CAS 26100-47-0), ethoxylated oleylamine (CAS 26635-93-8), acrylamide/sodium acryloyldimethyltaurate copolymer (CAS 38193-60-1), 2-propenamide, polymer with 2-propenoic acid and sodium 2-propenoate (CAS 62649-23-4), alcohols, c6-c12, ethoxylated (CAS 68002-97-1), alcohols, c12-14, ethoxylated (CAS 68439-50-9), alcohols, c12-16, ethoxylated (CAS 68551-12-2), ammonium sulfate (CAS 7783-20-2), acrylamid (CAS 79-06-1), ptfe (teflon) (CAS 9002-84-0), polyacrylamide (CAS 9003-05-8), poly(acrylamide-co-acrylic acid) (CAS 9003-06-9), or any combination thereof.

In the so-called “water fracs” where there is no frac fluid system and only a friction reducer in water, the concentration of the friction reducer is very low (<5 lb/1000 gallons). In such a case, the turbulence-reducing polymer is less likely to cause significant damage but surface friction along the proppant pack pores can retard flow and thereby reduce conductivity. Such a situation can benefit from the second type of coating having hydrophobic and/or oleophobic properties to allow flowing fluids to slide off the proppant surfaces and through the pore spaces. A coating that is either hydrophobic and/or oleophobic can permit both materials to move by with reduced friction.

In the so-called “water fracs” where there is no frac fluid system and only a friction reducer in water, the concentration of the friction reducer is very low (<5 lb/1000 gallons). In such a case, the turbulence-reducing polymer is less likely to cause significant damage but surface friction along the proppant pack pores can retard flow and thereby reduce conductivity. Such a situation can benefit from the second type of coating having hydrophobic and/or oleophobic properties to allow flowing fluids to slide off the proppant surfaces and through the pore spaces. A coating that is neither hydrophobic nor oleophobic can permit both materials to move by with reduced friction.

Treatment in this manner can also result in improvement in removal of static water trapped in the interstices of the proppant particle surface and between the particles. This can help minimize water lock, and thus improve overall hydrocarbon production from a well by reducing the surface tension and the amount of force needed to remove the water from the pores and allow hydrocarbons to flow through the proppant pack.

Suitable materials for flash coating the proppant with such hydrophobic and/or oleophobic agents include, but are not limited to, superhydrophobic coatings such as those found in U.S. Pat. No. 8,431,220 (hydrophobic core-shell nano-fillers dispersed in an elastomeric polymer matrix); U.S. Pat. No. 8,338,351 (hydrophobic nanoparticles of silsesquioxanes containing adhesion promoter groups and low surface energy groups); U.S. Pat. No. 8,258,206 (hydrophobic nanoparticles of fumed silica and/or titania in a solvent); and U.S. Pat. No. 3,931,428 (hydrophobic fumed silicon dioxide particles in resin) and the durable hydrophobic coatings of U.S. Pat. No. 8,513,342 (acrylic polymer resin, polysiloxane oil, and hydrophobic particles); U.S. Pat. No. 7,999,013 (a fluorinated monomer with at least one terminal trifluoromethyl group and a urethane resin); and U.S. Pat. No. 7,334,783 (solid silsesquioxane silicone resins), or any combination thereof. Additional materials that can be used include, but are not limited to, aliphatic or aromatic polymers that exhibit water contact angles of greater than about 90°, such as polybutadiene-containing polymers, polyurethanes with high proportions of soft segments (e.g., aliphatic segments), polymethylmethacrylate, and siloxane resins, including polydimethylsiloxane, or any combination thereof.

The use of a hydrophobic coating on the proppant can also have the effect of preventing water from reaching the surface of the sand grain. It has long been documented that uncoated sand's conductivity decreases with an increasing test temperature. This implies that the combination of elevated temperature and water contact may be damaging to the integrity of the sand particle and the corresponding proppant pack. Therefore, a hydrophobic coating can be used to slow down or minimize the detrimental effects that are observed with increased temperature in water-rich environments like those found downhole.

If some embodiments, the proppant is coated with multiple coatings. In some embodiments, the proppant is coated with a first layer of hydrophobic/oleophobic coating followed by a turbulence-reducing coating. Such a layered structure can permit the treated proppant to both reduce turbulence from separation of the top layer and then reduce surface drag by the flowing fluids by the underlying layer.

Friction reducing coatings can also take the form of materials with a low external, interparticle friction that function as a slip aid. A suitable material for use as such an slip aid is a product sold under the tradename POLYOX from Dow Chemical. This material is a nonionic water-soluble poly(ethylene) oxide polymer with a high-molecular weight.

Tracer Coatings.

Tracers are radioactive isotopes or non-radioactive chemicals that are injected in a well at specific sites with the intent that they will come out in detectable levels at some point in the effluent. Thus, they allow flow tracking of injected fluids from the source of introduction to the effluent stream. In addition, tracers that are location-specific can be used to track production of fluids from specific areas/zones in a well. Often, the tracers are introduced as an additive into the fracturing fluid during completion of a particular zone of interest.

Common radio-isotope chemistries used as tracers include tritiated water (³H₂O); tritiated methane (³CH₄); ³⁶Cl-¹³¹I-; ³⁵SO₄²⁻; S¹⁴CN⁻; H¹⁴CO³⁻; and ²²Na⁺.

Common non-radioactive tracer chemicals include halohydrocarbons, halocarbons, SF₆, and cobalt hexacyanide, where the cobalt is present as an anionic complex because cationic cobalt can react and precipitate downhole. Various organic compounds of usefulness include sulfonic acids and salts of those acids, mapthalenediol, aniline, substituted analine, and pyridine.

Tracers can be embedded in proppants but usually require actual movement of the proppant particle out of the well (i.e., flowback). The tagged proppant particle itself is then collected as a sample and analyzed for the presence/absence of the tracer. See U.S. Pat. Nos. 7,921,910 and 8,354,279. Others have sought to incorporate non-radioactive tagging chemicals into the proppant resin coating, but such an introduction method has required custom proppant formulations that must be manufactured well in advance of planned usage in a particular well. This can cause issues as the reactive phenolic coated proppants can sometimes have short useful shelf life as the taggants must be released before the phenolic resin becomes fully cured.

One feature in common among the tagged proppant techniques to date is that all of them require substantial pre-planning for production of multiple, different, tagged proppants for different well zones in advance of injection. For example, if five different zones need to be mapped, five different tagged proppant formulations might be needed. This means that five different types of proppants must be prepared at the resin coating plant and stored in inventory by either the proppant manufacturer or by the well completion group.

The present methods and processes occur so quickly and with such small amounts of applied polymers, resins, or organic compounds that the same tracers, metals, salts and organic compounds could be used as have been used previously in resin coating facilities. Additionally, new polymers or oligomers can be used that contain specific functional groups that have not been previously used, such as fluorescent dyes or phosphorescent pigments that can be detected in even small quantities in produced effluent, whether water or hydrocarbon. Suitable fluorescents include coumarins, napthalimides, perylenes, rhodamines, benzanthrones, benzoxanthrones, and benzothioxanthrones. Phosphorescent pigments include zinc sulfide and strontium aluminate. The coating used in the present process can be tailored to allow for selective or timed release leaching of the tracer salts from the coating into the downhole environment. This would allow the effluent to be used for analysis rather than requiring an analysis of recovered proppants in the flowback. In addition, very short lead times can be gained through use of this process, to allow greater flexibility for the customer to specify numbers of different tagging sections needed in a particular well. In some embodiments, the coatings applied by the processes described herein are applied immediately before moving the sand from terminals into containers for shipment to the well pad. This means that the inventory is reduced to the containers of tracer agent.

Some metal agents, e.g., tin and copper, that were previously used as biocides can also serve the function of a tracer in a proppant coating.

Suitable polymers to prepare tracer coatings include acrylate copolymers with hydrolysable silylacrylate functional groups, such as those described by U.S. Pat. No. 6,767,978. Briefly described, such polymers are made from at least three distinct monomers units selected from the group consisting of fluorinated acrylic monomers, (e.g. 2,2,2-Trifluoroethylmethacrylate (matrife)), triorganosilylacrylic monomers, (e.g., trimethylsilyl methacrylate) and acrylic monomers not containing an organosilyl moiety, (e.g. methyl methacrylate). The three component polymer (i.e. terpolymer) can optionally contain from 0-5 weight percent of a crosslinking agent. Such polymers are a copolymers comprising the reaction product of:
a) a monomer of the formula:

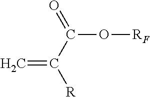

wherein:
R is CH₃ or H, and
RF is (C)ᵤ(CH)ᵥ(CH₂)_{w}(CF)ₓ(CF₂)_{y}(CF₃)_{z} where u is from 0 to 1, v is from 0 to 1, w is from 0 to 20, x is from 0 to 1, y is from 0 to 20, z is from 1 to 3, and the sum of w and y is from 0 to 20,
b) a monomer of the formula:

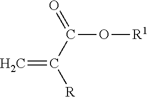

wherein: R is CH₃ or H, and R¹ alkyl or aryl, and
c) a monomer of the formula:

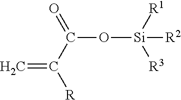

wherein:
R is CH₃ or H, and
R¹, R², and R³ can be the same or different and are non-hydrolysable alkyl groups containing from 1 to 20 carbon atoms and/or non-hydrolysable aryl groups containing from 6 to 20 carbon atoms.

In addition, depending on the chemistry used, metal-containing tracer moieties can also be used as biocides, similar to marine antifouling coatings. For example, tin and copper are commonly used as biocides in marine paints. These metals or their salts could also be incorporated into the acrylate latexes for flash coating onto the proppant or added to insoluble polymers for permanent attachment to the exterior of the proppant surface.

Suitable water soluble and dissolvable polymers are described in U.S. Pat. No. 7,678,872. Such polymers can be applied to proppants according to the present flash coating process to allow for introduction timed release functionality of the tracers into the produced fluid as the polymer swells or dissolves while also serving to control fugitive dust from the proppant.

Impact Modifiers.

Fines in a well can severely affect the conductivity of a proppant pack. Production of 5% fines can reduce conductivity by as much as 60%. Particle size analysis on pneumatically transferred 20/40 sand with a starting fines distribution of 0.03% showed an increase in fines to 0.6% after one handling step, and 0.9% after two handling steps prior to shipment to a well pad. Transport and further handling at the well site will likely also produce significantly more impact-related fines.

The processes described herein can be used to coat proppants with polymers specifically designed to be more deformable, which will greatly aid in the reduction of impact induced fines production. These polymers reduce the number of grain failures when closure stress is applied, effectively increasing the K value of the proppant, and can reduce fines migration by keeping failed grains encapsulated.

There are at least three ways that a thin, deformable coating on a proppant can improve fracture conductivity. The first is a benefit addressing the handling process. An additive that controls/prevent the generation of dust (through handling and pneumatic transfer) is helping to minimize the generation and inclusion of fine particles that are created through movement of such an abrasive that material as uncoated sand. Without wishing to be bound by any theory, the process that causes the creation of fines is simultaneously creating weakened points everywhere the grain was abraded. Conductivity tests have documented that uncoated sand samples that were moved pneumatically had measurably lower conductivity than the same sand not so handled. The impact-modifying polymer coating can further reduce grain failure by spreading out point-to-point stresses that occur when one grain is pushed against another during the closure of the fracture and subsequent increase of closure stress that occurs as the well is produced. The deformable coating effectively increases the area of contact between two grains. This increase in contact area reduces the point loading that is trying to make the grains fail. Minimizing the generation of fines that occur either during handling or from the pressure applied in the fracture, will mean there are less fines that can be mobilized to create conductivity damage. If the flash coating results in a uniformly distributed film around the sand grain, the coating can be an effective means of preventing fines movement through the encapsulation of any failed grains. Preventing or minimizing the movement of fines can result in controlling a condition that has been proven to be capable of reducing fracture conductivity by as much as 75%.

In some embodiments, for an impact modified layer, the layer comprises lower Tg polyurethanes or lightly crosslinked polyurethanes. The polyurethane formula could be tailored for lower Tg and better resilience by using a very soft polyols (e.g., polybutadiene-based polyols with very light crosslinking). Another embodiment uses the application of a thin coating of polybutadiene polymer as the impact layer. Such a flash coating is applied with either a latex-based or solvent-based formulation, and a peroxide for lightly curing/crosslinking the polybutadiene coating. Other embodiments include, but are not limited to, other rubbery polymers including polyisoprene, polychloroprene, polyisobutylene, crosslinked polyethylene, styrene-butadiene, nitrile rubbers, silicones, polyacrylate rubbers, or fluorocarbon rubbers. The rubber or gum should be in a water-based latex or dispersion or dissolved in a solvent for spray application.

Polybutadiene coatings with unreacted vinyl or alkene groups can also be crosslinked through use of catalysts or curative agents. When catalysts, fast curatives, or curatives with accelerants are introduced during processes described herein, the result will be a very hard, tough coating. Alternately, curative agents can be added that will activate thermally after the materials are introduced downhole at elevated temperatures. This may have the effect of having a soft rubbery coating to protect against handling damage, but that soft rubbery coating could then convert to a hard coating after placement downhole at and cured elevated temperatures.

Curative agents that can be used are those that are typically used for rubbers, including sulfur systems, sulfur systems activated with metal soaps, and peroxides. Accelerators such as sulfonamide thiurams or guanadines might also be used, depending on cure conditions and desired properties. Other curing catalysts could also be employed to perform similarly include ionic catalysts, metal oxides, and platinum catalysts.

Additive Delivery.

“Self-suspending proppants” can have an external coating that contains a water swellable polymer that changes the proppant density upon contact with water. See, for example, U.S. 2013/0233545. Such coatings are taught to have about 0.1-10 wt % hydrogel based on the weight of the proppant and can contain one or more chemical additives, such as scale inhibitors, biocides, breakers, wax control agents, asphaltene control agents and tracers.

In some embodiments, the water swellable polymer can be applied by processes described herein and present at a much lower concentration, e.g., less than about 0.1 wt %, or from about 0.001 to about 0.07 wt %. At such low levels, the swellable coating is unlikely to produce a self-suspending proppant but, rather, imparts enhanced mobility relative into the fracture to untreated sand while also providing dust control as well as a delivery system upon contact with water for biocides and tracers. For example the swellable polymer coating could act as a dust control when first applied, could swell to enhance mobility for placement, and could also contain tracers, biocides, or other active ingredients that could be released over time through diffusion out of the swollen polymer.

Soluble and semi-soluble polymers that can be used as delivery coatings include, but are not limited to, 2,4,6-tribromophenyl acrylate, cellulose-based polymers, chitosan-based polymers, polysaccharide polymers, guar gum, poly(1-glycerol methacrylate), poly(2-dimethylaminoethyl methacrylate), poly(2-ethyl-2-oxazoline), poly(2-ethyl-2-oxazoline), poly(2-hydroxyethyl methacrylate/methacrylic acid), poly(2-hydroxypropyl methacrylate), poly(2-methacryloxyethyltrimethylammonium bromide), poly(2-vinyl-1-methylpyridinium bromide), poly(2-vinylpyridine n-oxide), polyvinylpyridines, polyacrylamides, polyacrylic acids and their salts (crosslinked and partially crosslinked), poly(butadiene/maleic acid), polyethylenglycol, polyethyleneoxides, poly(methacrylic acids, polyvynylpyrrolidones, polyvinyl alcohols, polyvinylacetates, sulfonates of polystyrene, sulfonates of polyolefins, polyaniline, and polyethylenimines, or any combination thereof.

Biocidal Coatings.

A number of nonpolymeric biocides have been used in fracturing fluids. Any of these can be used in solid forms or adsorbed into solid or dissolvable solid carriers for use as additives in an applied coating according to the present disclosure to impart biocidal activity to the proppant coatings. Exemplary biocidal agents include, but are not limited to: 2,2-dibromo-3-nitrilopropionamide (CAS 10222-01-2); magnesium nitrate (CAS 10377-60-3); glutaraldehyde (CAS 111-30-8); 2-bromo-2-cyanoacetamide (CAS 1113-55-9); caprylic alcohol (CAS 111-87-5); triethylene glycol (CAS 112-27-6); sodium dodecyl diphenyl ether disulfonate (CAS 119345-04-9); 2-amino-2-methyl-1-propanol (CAS 124-68-5); ethelenediaminetetraacetate (CAS 150-38-9); 5-chloro-2-methyl-4-isothiazolin-3-one (CAS 26172-55-4); benzisothiazolinone and other isothiazolinones (CAS 2634-33-5); ethoxylated oleylamine (CAS 26635-93-8); 2-methyl-4-isothiazolin-3-one (CAS 2682-20-4); formaldehyde (CAS 30846-35-6); dibromoacetonitrile (CAS 3252-43-5); dimethyl oxazolidine (CAS 51200-87-4); 2-bromo-2-nitro-1,3-propanediol (CAS 52-51-7); tetrahydro-3,5-dimethyl-2h-1,3,5-thia (CAS 533-73-2); 3,5-dimethyltetrahydro-1,3,5-thiadiazine-2-thione (CAS 533-74-4); tetrakis hydroxymethyl-phosphonium sulfate (CAS 55566-30-8); formaldehyde amine (CAS 56652-26-7); quaternary ammonium chloride (CAS 61789-71-1); C₆-C₁₂ ethoxylated alcohols (CAS 68002-97-1); benzalkonium chloride (CAS 68424-85-1); C12-C14 ethoxylated alcohols (CAS 68439-50-9); C12-C16 ethoxylated alcohols (CAS 68551-12-2); oxydiethylene bis(alkyldimethyl ammonium chloride) (CAS 68607-28-3); didecyl dimethyl ammonium chloride (CAS 7173-51-5); 3,4,4-trimethyl oxazolidine (CAS 75673-43-7); cetylethylmorpholinium ethyl sulfate (CAS 78-21-7); and tributyltetradecylphosphonium chloride (CAS 81741-28-8), or any combination thereof.

Alternatively, an erodible outer coating with a timed release or staged release can be used that will dissolve and/or release included additives into the groundwater or hydrocarbons downhole. Such coatings can be based on polymers that were substantially insoluble in cool water but soluble in water at downhole temperatures where the active is intended to begin functioning shortly after introduction. Alternatively, the outer layer coating can be prepared in such a way as to render it insoluble in the well fluids and subject to release when crack closure stresses are applied.

The time frame for release of an encapsulated ingredient (biocide, scale inhibitor, etc.) via diffusion can be tailored based on the crosslink density of the coating. A polymer with little to no crosslinking can result a fast dissolving coating. Highly crosslinked materials can have a much slower release of soluble ingredients in the coating. If mobility of the chemicals of interest is too low in a crosslinked membrane, dissolvable fillers like salts, organic crystalline solids, etc. can be incorporated in the coating mixture. Once the coated proppant is introduced downhole, the particles can dissolve to leave larger pores as done for filtration membranes. See U.S. Pat. No. 4,177,228. Insoluble polymers like the thermosets (e.g., alkyds, partially cured acrylics, phenolics, and epoxies) and thermoplastics (e.g., polysulfones, polyethers, and most polyurethanes) can also be used as insoluble outer coatings applied as described herein. Alkyds, which are polyesters, are likely to hydrolyze over time under the hot, wet downhole conditions and can thereby use this property to impart a delayed release through combination of environmental hydrolysis and situational erosion. Polyamides, which can hydrolyze and degrade over time, can be used as well for this type of coating.

Coatings can be prepared by mixing thermoset polymers with the soluble fillers and applying them to the proppant particles according to the various embodiments described herein. Thermoplastic membrane coatings can be applied via dissolving in solvent, mixing with the soluble fillers, and coating the resulting mixture onto the proppant particles with subsequent removal of the solvent by drying with pneumatic conveyance air or air forced through the coated materials Timings for release can be tailored by proper selection of filler size, shape, and filler concentration.

Biocidal polymer coatings. Biocides are often used at low concentrations in the hydraulic fracturing fluid mixtures, on the order of 0.001% in the fracturing fluid, which corresponds to approximately 0.01% of the total proppant weight. Microorganisms have a significant economic impact on the health and productivity of a well. For example, unchecked bacteria growth can result in “souring” of wells, where the bacteria produces hydrogen sulfide as a waste product of their metabolic function. Such sour gases in the produced fluids are highly undesirable and can be a source for corrosion in the production equipment as well as a cost for sulfur removal from the produced hydrocarbons.

Therefore, in some embodiments, a biocidal polymer can be applied to the proppants as an aid to both fugitive dust control as well as inhibition of bacterial growth downhole. Suitable polymers that can be used as biocides include: acrylate copolymer, sodium salt (CAS 397256-50-7), and formaldehyde, polymer with methyloxirane, 4-nonylphenol and oxirane (CAS63428-92-2), or any combination thereof.

In addition, depending on the chemistry used, metals used as marine antifouling coatings can also serve as biocides on a proppant. For example tin and copper are commonly used as biocides in marine paint. These same agents could be incorporated into the acrylate latexes for flash coating onto the proppant as a biocidal coating.

Sulfide Control.

Hydrogen sulfide is a toxic chemical that is also corrosive to metals. The presence of hydrogen sulfide in hydrocarbon reservoirs raises the cost of production, transportation and refining due to increased safety and corrosion prevention requirements. Sulfide scavengers are often used to remove sulfides while drilling as additives in muds or as ingredients in flush treatments.

Depending on the concentration of hydrogen sulfide in the fractured reservoir, the concentrations of the scavengers included on the surface of the proppant can be varied to remove more or less hydrogen sulfide. In sufficient volume, proppants with sulfide scavenging capabilities can reduce the concentration from levels that pose safety hazards (in the range of 500-1000 ppm) to levels where the sulfides are only a nuisance (1-20 ppm). If the surface area of the proppants is high and dispersion of the scavengers is good, high efficiencies in hydrogen sulfide reaction and removal are possible.

A timed release dosage can be delivered according to the present disclosure by including copper salts, such as copper carbonate (CuCO₃), in the proppant that can be delivered very slowly into the fracture to treat hydrogen sulfide before it can reach steel components in the wellbore.

Zinc oxide (ZnO) and ferric oxide (Fe₂O₃) are used directly as solid particulates to address hydrogen sulfide. These can be incorporated onto the surface of coated proppants or be formed as functional fillers within the proppant coating that is applied. The use of high surface area fillers, even nanometer-sized particulates, can be used to maximize the interaction area between the hydrogen sulfide and the metal oxide.

Also useful are oxidizing agents, such as solid forms of oxidizing agents. Exemplary materials include solid permanganates, quinones, benzoquinone, napthoquinones, and agents containing quinone functional groups, such as chloranil, 2,3-dichloro-5,6-dicyanobenzoquinone, anthroquinone, and the like, or any combination thereof.

Polymers with pendant aldehyde groups can also be used introduce an aldehyde functionality in a proppant coating for control of hydrogen sulfides. Polyurethanes can be made with such functionalities. See U.S. Pat. No. 3,392,148. Similarly, other polymers can be formed with pendant aldehyde groups, such as polyethers, polyesters, polycarbonates, polybutadiene, hydrogenated polybutadiene, epoxies, and phenolics, or any combination thereof.

In addition, dendrimers can be prepared with multiple terminal aldehyde groups that are available for reaction. These aldehyde-rich dendrimers can be used as fillers, copolymers, or alloys and applied to the proppants as a coating, or a layered coating.

Dioxole monomers and polymers allow introduction of this functionality as pendant groups in polymers. Such dioxane functional groups can serve as oxidative agents to control the production of hydrogen sulfides. Homopolymers of dioxole can be used as well as copolymers of dioxoles with fluorinated alkenes, acrylates, methacrylates, acrylic acids and the like.

Amines and triazines also used as scavengers for hydrogen sulfide. Amine-terminated polymers or dendrimers can be used and have the advantage of being tethered to a polymer so they can stay in place in a proppant coating. High functionality can be achieved by the use of dendrimers, i.e., using multiple functional groups per single polymer molecule.

Triazines can be incorporated into polyurethane crosslink bridges via attachment of isocyanates to the R groups of the triazines. See U.S. Pat. No. 5,138,055 “Urethane-functional s-triazine crosslinking agents”. Through variations of the ratio of —OH groups and the use of triol functionality and monofunctional triazine isocyanate, pendant triazines can also be prepared. These functionalized polymers can be added as fillers or prepared as the coating itself to both impart fugitive dust control as well as hydrogen sulfide control downhole.

Metal carboxylates and chelates, some of which are based on or contain zinc or iron, can be used on proppants to remove hydrogen sulfide. See U.S. Pat. No. 4,252,655 (organic zinc chelates in drilling fluid). These carboxylates or chelates are provided in the proppant coating as water soluble complexes which, upon interaction with hydrogen sulfide in-situ downhole, will form insoluble metal sulfates.

Hydrogen sulfide can also be controlled with polymers having functional groups that can act as ligands. Polycarboxylates that have been pretreated with metals to create metal carboxylate complexes can be mixed with other polymers, such as those described elsewhere herein, and applied as a coating to proppant particles. This is also applicable to other polymers with pendant functional groups that act as complexing ligands for sulfide, such as amines and ethers.

In some embodiments, the metals used for sulfide control are not present as a complex in the polymeric backbone so that removal of the metal would not have to involve polymer decomposition. Polymers with metal side chain complexes can be used. Polyvinylferrocenes, polyferrocenylacrylates are two such examples of this class of material. In some embodiments, the main chain metal containing polymer can also be used, but the polymer will degrade upon reaction with hydrogen sulfide.

If the production fluid which contains hydrogen sulfide at a basic pH (i.e., pH of greater than 7 or greater than 8-9), most of the hydrogen sulfide will be present as HS-anion. In this case, anion exchange resins or zeolites can be used to extract the HS-anions from the fluid. The zeolites or anionic exchange resins can be used as active fillers in a resin coated proppant composition include aluminosilicates such as clinoptilolite, modified clinoptilolite, vermiculite, montmorillonite, bentonite, chabazite, heulandite, stilbite, natrolite, analcime, phillipsite, permatite, hydrotalcite, zeolites A, X, and Y; antimonysilicates; silicotitanates; and sodium titanates, and those listed in U.S. Pat. No. 8,763,700, the disclosure of which is hereby incorporated by reference. Suitable ion exchange resins are generally categorized as strong acid cation exchange resins, weak acid cation exchange resins, strong base anion exchange resins, and weak base anion exchange resins, as described in U.S. Pat. No. 8,763,700. Hydrogen sulfide that is produced through biological activity is controlled through use of biocides and biocidal coatings (as discussed above), and removal of sulfate anions (HSO₄⁻ or SO₄⁻²). Anion exchange resins can be used for removal of sulfate. Nitrates can also be used to disrupt the sulfate conversion by bacterial. Nitrate salts can also be added in a coating layer and then protected from premature release with an erodible or semipermeable coating to allow an extended release of the nitrates.

Composite Coatings.

In some embodiments, the processes described can be carried out effectively in series, and such a process provides a cost-effective process to apply multiple layers of coatings with different compositions and different functional attributes. A variety of combinations are possible. For example, in some embodiments, multiple spray heads could be used, each of which can apply a different formulation. If the successive coating formulation is chemically incompatible in that the applied layer does not wet the undercoated layer, one or more primer agents, e.g., block or graft copolymers with similar surface energies and or solubility parameters as the two incompatible layers, can be used for better interfacial bonding. The different spray heads can also be used to apply the same formulation if multiple layers are desired. Some examples of composite coatings include the following.

Two layers for improved proppant physical performance. Different, successive layers are applied with different performance characteristics, such as a hard urethane layer (urethane, crosslinker (such as polyaziridine), and isocyanate) followed by an outer, softer urethane layer. This coating structure can allow some compaction for proppant particle bonding due to the soft outer layer but inhibit further compaction/crushing due to the hard inner layer. The relatively softer outer layer can also tend to reduce interparticle impact damage as well as wear damage on the associated handling and conveying equipment used to handle the proppants after the flash coating was applied.

Successive layers for a timed release functionality. Successive layers can be used to add a first layer with an additive having a first functionality followed by a second layer having properties that control when and how ambient liquids get access to the first layer additive materials. For example, a soft, lightly crosslinked urethane layer with biocide additives is covered with a hard urethane layer that contains dissolvable particles. When the dissolvable particles are removed, the outer coating forms a semipermeable coating that allows slow diffusion of the underlying biocidal additive.

Layers of strongly-bonded polymer followed by weakly-bonded polymer. A silane treatment for silica compatabilization can be applied to the sand proppant outer surface. This treatment is followed by coating with an inner polymer layer containing functional additives, such as Fe₂O₃ particulates to provide sulfide scavenging. The outer layer coating contains polyacrylamides that are loosely bonded to the first coating. Once downhole, the polyacrylamide is released and collects on the internal surfaces of metal pipes in the well. This formulation can deliver friction reduction in the short term and offer a level of sulfide control over the lifetime of the well until the iron oxide particles were fully exhausted.

Staged Release Coatings.

For example, oxygen related corrosion and asphaltene often are more problematic at the beginning of a well life cycle, while bacterial growth occurs later in the well life cycle. A composite coating of three layers can address such delayed developments. The first, innermost, layer can comprise, for example, a biocidal functionality. The second coating layer can comprise, for example, an asphaltene inhibitor, and the third layer can comprise, for example, a loosely bound polyhydroxyl compound as an oxygen scavenger. The outer layer of this proppant can reduce oxygen levels immediately, especially in dead zones/zones of limited flow from the entrance of the well, which can't be flushed with fluids containing oxygen scavengers. As the well begins production, the outer layer can be consumed and erode from the surface to expose the asphaltene-inhibiting layer of a sulfonated alkylphenol polymer that can also erode or dissolve over time. As the well continues to produce, asphaltene issues can lessen, and the remaining innermost coating can slowly release its biocides to ensure continued health of the well. A single, composite provides these extended benefits with less cost and easier logistics than the use of multiple proppants with different functions introduced into the well as a mixture.

Timed Release Coatings.

The use of an outer layer made with dissolvable particles and/or dissolvable or erodible polymers can be used to provide a controlled, timed release of functional additives much like an enteric coating of a medicament. Unlike a staged release structure, a timed release coating does not have a second stage of release. Importantly, the coated proppants according to the present disclosure provide for release over time, in situ, and throughout the fractured strata. Exemplary functional additives can include biocides, scale inhibitors, tracers, and sulfide control agents. Suitable water soluble and dissolvable polymers are described in U.S. Pat. No. 7,678,872. Erodible matrix materials include one or more cellulose derivatives, crystalline or noncrystalline forms that are either soluble or insoluble in water.

The time frame for release of an encapsulated ingredient via diffusion can be adjusted and tailored to the need by adjusting the crosslink density of the encapsulating coating. A polymer with little to no crosslinking exhibits a fast-dissolving coating for a short interval before release. Highly crosslinked materials can have a much slower rate of release of soluble ingredients in the coating. If mobility of the chemicals of interest is too low in a crosslinked membrane, dissolvable fillers like salts, organic crystalline solids, etc. can be incorporated in the coating mixture. Once the coated proppant is introduced downhole, the particles can dissolve to leave larger pores, as has been done with filtration membranes as in U.S. Pat. No. 4,177,228 entitled “Method of Production of a Micro-Porous Membrane for Filtration Plants.” If lightly crosslinked or a hydrogel, the polymer swells and will allow a controlled diffusion of the encapsulated additives.

Insoluble polymers, such as the thermosets (e.g., alkyds, partially-cured acrylics, phenolics, and epoxies) and the thermoplastics (e.g., polysulfones, polyethers, and polyurethanes) can be used as thin coatings with dissolvable additives. Such coatings are prepared by mixing, e.g., a thermoset polymer with finely divided, dissolvable solids and applying the resulting mixture to the proppant particles. Thermoplastics can be applied by dissolving the thermoplastic polymer in a solvent, mixing in the finely divided, dissolvable solids, and coating the proppants with the mixture. The solvent is then removed with a drying stage, which may be no more than a cross-flowing air stream. The time before release can be adjusted based on the size, shape, and solids concentration.

In some embodiments, the processes described herein provide for the formation of a self-polishing coating that dissolves over time or is eroded as fluid passes over the surface of the coating. Suitable materials for such coatings include acrylate copolymers with hydrolysable silylacrylate functional groups. (See U.S. Pat. No. 6,767,978.) Alkyds, which are polyesters, can also be used as they tend to hydrolyze over time under downhole conditions and thereby impart a delayed-release mechanism through combination of hydrolysis and erosion.

Cellulosic coatings can also provide a timed release coating. Suitable and include, but are not limited to, the hydroxyalkyl cellulose family such as hydroxyethyl methylcellulose and hydroxypropyl methylcellulose (also known as hypromellose). A suitable material is commercially available under the tradename METHOCEL from Dow Chemical. This material is a cellulose ether made from water-soluble methylcellulose and hydroxypropyl methylcellulose polymers. Rheological modification can also be provided from the use of a hydroxyethyl cellulose agent, such as those commercially available under the tradename CELLOSIZE, from Dow Chemical.

Polyamides, which can be hydrolyzed under downhole conditions, can be used as well.

Acid/Base-Resistant Coatings.

Chemical attack of a proppant is a concern in hydraulic fracturing. For silica sand, the acid number of a proppant is often used to designate the sand's quality. The test in ISO 13503-2, section 8 describes the specific testing of proppant sand under acid exposure as a way to determine its suitability for specific well conditions. If components or impurities in the sand dissolve or are unstable in acidic environments, the proppant grains will gain porosity and exhibit a lower overall crush resistance. It can, therefore, be desirable to have a coating that could minimize the attack on the silica sand by acids found in downhole groundwaters.

Basic solutions can also dissolve or partially degrade silica proppants and the resin coating on such proppants, especially at a pH of nine or higher. This can cause issues in conductivities of proppant packs placed in fractures, due to weakening of the grains and possible reduction in particle size due to dissolving of outer layer of the particles.

Ceramic proppants can also suffer under highly basic or acidic waters as a result of diagenesis, a phenomenon in which the ceramic dissolves in aqueous solutions under pressure followed by a re-precipitation with other elements present in the fluid. The re-formed solid is unlikely to be as strong or the same size as the original ceramic proppant and can be a significant concern for its effects on conductivity of a ceramic proppant pack.

In some embodiments, the coatings that are applied are acid resistant, base resistant, or both, and can offer new protections for proppants of all types, including, but not limited to, sand and ceramic proppants. Some of the acid-resistant polymers that can be applied include: polypropylene, acrylic polymers, and most fluoropolymers. For increased coverage of the total exterior surface of the proppants, multiple coating applications of the same base polymer might be needed, depending on the equipment and number of dispersion nozzles that are used. The processes described herein can be repeated until the appropriate number of coatings are applied.

Suitable base-resistant polymers include the polyolefins, some fluoropolymers (except that PVDF and FKM are not particularly resistant to strong bases) and many polyurethanes.

Corrosion Inhibitors.

Corrosion of metals in downhole applications is a significant problem in the oil and gas industry. Corrosion can occur via either an acid-induced process or via oxidation. Acidic conditions can be caused by acid treatment of the formation, acid or H₂S producing bacteria, or CO₂ that can dissolve in water under pressure to form carbonic acid. Oxidation/oxidative corrosion of the metal can occur in the presence of water and oxygen.

Corrosion in downhole applications is often addressed by addition of corrosion inhibitors and/or acid scavengers during drilling, completion, or hydraulic fracturing. The corrosion inhibitor provides a coating to passivate the metal surfaces exposed to the fluids. Passivating layers of small molecules are also applied via addition of these molecules in a treating fluid, followed by use of complexation chemistry to attach the molecules to the metal, e.g., the use of active ligand sites on small organic molecules or polymers to bind to the metal. Acid scavengers are acid-accepting and basic compounds. Periodic washing or flushing with fluids containing such materials after the initial treatment is also a common method to keep corrosion under control.

Oxygen scavengers are used to remove dissolved oxygen from downhole fluids. Once a well is completed, oxygen is not usually a significant problem as it is not normally present in producing formations, but it can be a problem in drilling muds and fracture fluids. Oxygen scavengers are used in these fluids during drilling, fracturing or completion.

Polymeric coatings for the metallic surfaces to prevent corrosion are often used, and applied to the metals prior to their use. Baked resins, or epoxy coatings, are two examples, but other polymers can be used on the metals. Cathodic protection is also used where possible, by placing a more reactive metal near the metal to be protected, and using the more reactive metal to react or oxidize with the chemistries in the fluid, rather than the metals which are desired to be protected. Zinc, aluminum and other metals which are more reactive than iron (Fe) are used for cathodic protection.

Chemicals that can be applied to the solids for corrosion protection include 1-benzylquinolinium chloride (CAS 15619-48-4), acetaldehyde (CAS 57-07-0), ammonium bisulfite (CAS 10192-30-0), benzylideneacetaldehyde (CAS 104-55-2), castor oil (CAS 8001-79-4), copper chloride anhydrous (CAS 7447-39-4), fatty acid esters (CAS 67701-32-0), formamide (CAS 75-12-7), octoxynol 9 (CAS 68412-54-4), potassium acetate (CAS 127-08-2), propargyl alcohol (CAS 107-19-7), propylene glycol butyl ether (CAS 15821-83-7), pyridinium, 1-(phenylmethyl)-(CAS 68909-18-2), tall oil fatty acids (CAS 61790-12-3), tar bases, quinoline derivatives, benzyl chloride-quaternized (CAS 72480-70-7), and triethylphosphate (CAS 78-40-0), or any combination thereof.

Corrosion inhibitors that are solids can be mixed into resin formulations as a filler, then applied to proppants to form a coating that can deliver the corrosion protection directly downhole. The coatings can be designed to deliver corrosion protection immediately, as might be desired for oxygen scavengers during drilling or completion. The coatings can also be tailored for timed release of corrosion, as discussed above. Cathodic protection can be provided by also including one or more metal particles (Zn, Al, and the like) in highly conductive produced waters/brines.

Corrosion inhibitors that are liquids can be introduced into these systems via selection of a polymer proppant coating in which the liquids/organic chemicals are miscible or semi-soluble. Some examples include digycolamines mixed with polyacrylamides, or lightly crosslinked or thermoplastic polyurethanes.

Other polymers, such as 2-vinyl-2-oxyzoline can be used as water soluble polymer fillers that can be encapsulated in a resin coating on proppant particles, and dissolved over time from the coating. The soluble molecules can then passivate metal surfaces, and inhibit acidic corrosion.

Acid scavenging activity can be provided with a flash coating of polymers having acid scavenging attributes. For example, polymers with nitrogen containing heteroatoms such as polyvinylpyridine and polyvinylpyrrolidone, carboxylates, or pendant amines can provide such acid scavenging activity, i.e., nitrogen can interact with acids to form a salt. The scavenging power of these polymers can be related to the concentration of functional groups on the polymer as well as the mobility and accessibility of these groups to react with the produced fluids and remove acidic impurities.

Improvement in Crush Resistance.

Water-based dispersions of precured polyurethanes can be mixed with a polyurethane crosslinking agent such as polyaziridine, isocyanate or carbodiimides to generate a hard, crosslinked, coating in low concentration. Variations of the nature and amount of the crosslinking agent, as exists for one of no more than an ordinary level of skill in this art, allow the cure levels of the coating to be adjusted and tailored for more or less hardness, crosslink density, glass transition temperature, and permeation rate. In some embodiments, coating levels per treatment of up to 0.5% or 01-0.3 wt % based on the weight of the proppant can be applied. In some embodiments, multiple coatings are applied to generate thicker coatings, if desired. In some embodiments, the proppant has, or at least, 1, 2, 3, 4, 5, 6, 7, 8, 9, or 10 coatings.

Increased crush resistance (“K values”) can be obtained with polyurethane-treated proppant sand relative to its untreated version at even low coating levels. See Table 3 below. Other types of thermoplastic and thermoset polymeric coatings should exhibit similar results.

TABLE 3
K values From Crush Tests, per ISO 13503-2

| | Crush test, | Improvement |
|---|---|---|
| PU Coating Weight | K value | over Raw Sand |
| 0% | 6 | 0% |
| (untreated 20/40 sand) | | (control) |
| 0.25% | 7 | 17% |
| 0.25% | 7 | 17% |
| 0.31% | 7 | 17% |
| 0.50% | 10 | 67% |
| 0.53% | 10 | 67% |

Paraffin Inhibitors.

Paraffins are long chain hydrocarbons, typically C₁₈ to C₁₀₀ or more (18-100 carbons) that often precipitate out of a hydrocarbon solution due to changes in temperature or composition that decrease the solubility of the paraffin in the hydrocarbon fluids. Once precipitated, those paraffins can crystallize to form a waxy buildup.

In some embodiments, paraffin inhibitors can be coated into or onto proppants. Such a coating places the treatment in the fractured strata and at the elevated temperatures found downhole before the paraffins have begun to precipitate or crystallize. By introducing the inhibitors in the fractured strata while the paraffins are still soluble, the treatment can affect the crystallization rate of paraffin as the produced hydrocarbon stream cools and/or mixes with water as it moves towards the surface and consolidates with other frac streams for recovery. Such conditions often result in reduced paraffin solubility and create conditions where paraffin precipitation and crystallization become problematic.

The paraffin inhibitors of the present disclosure can be added as a polymeric coating on the proppants or as released additives. The coated polymers can stay associated with the proppant particles until the proppant was exposed to hydrocarbons whereupon the polymers can dissolve in the hydrocarbon or mixed hydrocarbon/water effluent. Releasable additives contained in timed release or staged release coatings of the types discussed above allow the paraffin inhibitor additives to be released over time via diffusion out of the swelled or dissolving coating or by migration out of a coating whose soluble particulates had left openings for egress of the paraffin additives.

Polymers that can serve as paraffin inhibitors include, e.g., styrene ester copolymers and terpolymers, esters, novalacs, polyalkylated phenol, and fumerate-vinyl acetate copolymers. Tailoring the molecular weight of the inhibitor as well as the lengths of the pendant chains can be used to modify the nature of the inhibition effects. These characteristics affect both the crystallization rate and size distribution of paraffin crystals and thus the pour point of the resulting solutions.

Paraffin pour point can be decreased by adding solvents to a hydrocarbon mixture to increase solubility of paraffin, and thus reduce the crystallization rate and overall crystallite size distribution of the paraffin crystals. These are often copolymers of acrylic esters with allyl ethers, urea and its derivatives, ethylene-vinlyacetate backbone with unsaturated dicarboxylic acid imides, dicarboxylic acid amides, and dicarboxylic acid half amides.

Polymers that are useful for paraffin crystal modification include ethylene-vinyl acetate copolymers, acrylate polymers/copolymers, and maleic anhydride copolymers and esters.

Paraffin dispersants work via changing the paraffin crystal surface, causing repulsion of the paraffin particles and thus inhibit formation of larger paraffin agglomerates that could precipitate from suspension in the reservoir fluids. Typical chemistries include olefin sulphonates, polyalkoxylates and amine ethoxylates.

Asphaltene Inhibitors.

Asphaltenes are complex polycyclic aromatic compounds, often with heteroatoms and with aliphatic side chains. They are present in many hydrocarbon reserves at concentrations that vary from <1 to 20%. They are soluble in benzene or aromatic solvents but insoluble in low molecular weight alkanes.

Asphaltenes pose similar issues to the paraffins in that they are typically soluble in the pressurized, heated hydrocarbon mixture in a reservoir field, but changes in temperature and pressure during production from that reservoir can cause precipitation or flocculation. Either of these can have the effect of reducing fluid flow or, in the worst case, stopping fluid flow completely. Once the asphaltenes precipitate, the well must be remediated by mechanically scraping or dislodging the deposits through the application of differential pressures or by cleaning with toluene, xylene, or other suitable aromatic solvent. Cleaning is expensive and stops well production during the process so the asphaltene additives carried by treated proppants represent a substantial economic benefit for well owners and operators.

Asphaltene is controlled via use of dispersing additives or inhibitors. Dispersants reduce the particle size of the precipitated asphaltenes and keep them in suspension. Dispersants are often used as frac fluid additives at a point after asphaltene precipitation is likely to occur, i.e., after a pressure drop or temperature drop as the oil moves from the reservoir into the production channels. Dispersants are usually nonpolymeric surfactants. Some asphaltene dispersants that have been used in frac fluids include: very low polarity alkylaromatics; alklarylsulfonic acids; phosphoric esters and phosphonocarboxylic acids; sarcosinates; amphoteric surfactants; ethercarboxlic acids; aminoalkylene carboxylic acids; alkylphenols and their ethoxylates; imidazolines and alkylamine imidazolines; alkylsuccinimides; alkylpyrrolidones; fatty acid amides and their ethoxylates; fatty esters of polyhydric alcohols; ion-pair salts of imines and organic acids; and ionic liquids.

Inhibitors actually prevent the aggregation of asphaltene molecules and prevent precipitation. Asphaltene inhibitors are typically polymers. Common asphaltene inhibitors that have typically been used in frac fluids include: alkylphenol/aldehyde resins and sulfonated variants of these resins; polyolefin esters, amides, or imides with alkyl, alkylene phenyl, or alkylene pyridyl functional groups; alkenyl/vinylpyrolidone copolymers; graft polymers of polyolefins with maleic anhydride or vinylimidazole; hyperbranched polyesterimides; lignosulfonates; and polyalkoxylated asphaltenes.

Polymeric asphaltene inhibitors can be introduced directly as coatings on the proppant particles. They can be applied as coatings that can be released in a controlled fashion either immediately or slowly over time by the timed release and staged release coatings discussed above.

The asphaltene inhibitors can also be used as an additive in a polymeric coating.

Asphaltene dispersants can be used mainly as ingredients/fillers in a coating to be released over time. Their release over time can be controlled with the coatings discussed herein depending on whether an immediate release or timed release dosing is desired. Branched polymers with arms that contain the dispersant functionality can also be used where the branches are connected to the polymer backbone by reactive groups that might degrade over time, such as esters, hydrolysable groups, and the like to release the dispersants over time.

An advantage of using asphaltene control agents directly on proppant particles is that these agents can be released within the formation prior to asphaltene precipitation. Such an in-situ delivery allows effective treatment before development of the problem and in controlled concentrations.

Fines Migration Control.

In addition to higher crush resistance and decreased equipment wear from handling, flash coatings of the present disclosure can help control fines migration downhole and thereby help to maintain conductivity.

Fines produced through crushing of the proppant pack can fill a portion of the interparticle porosity, which is directly linked to conductivity. More importantly fines can be mobilized under pressure in downhole conditions during fluid production to cause a great amount of damage, sometimes more than a 75% reduction in conductivity.

The effect of fines migration is not obvious in a standard conductivity test, as the test is performed at too low of a flow rate to mobilize fines. Some control over fines migration downhole can be added to proppants by applying to the treated proppants an external tackifier that will capture fines encountered downhole. The coated proppants are then placed in the well during fracturing. This ensures the fines control treatment is accurately placed on the surface of the particles and ensures that the coating penetrates the fracture as deeply as the proppant particles.

Common tackifier resins or resin dispersions that can be used for fines control on a proppant include: a) rosin resins from aged tree stumps (wood rosin), sap (gum rosin), or by-products of the paper making process (tall oil rosin); b) hydrocarbon resins from petroleum based feedstocks either aliphatic (C₅), aromatic (C₉), dicyclopentadiene, or mixtures of these; and c) terpene resins from wood sources or from citrus fruit.

Removal of Anions/Halogens from Produced Water.

Halogens, particularly bromines, can cause issues in produced water due to the reaction with disinfectants to make disinfection by-product compounds. For bromide, a concentration value of 0.1 mg/L poses a risk for unintended by-product production. These by-products can also be potential carcinogens. For example, some by-product compounds have toxicologic characteristics of human carcinogens, four which are already regulated, e.g., bromodichloromethane, dichloroacetic acid, dibromoacetic acid, and bromate.

The removal of bromines can occur in the context of the present disclosure by adding anion exchange resins into or onto a resin coating on a proppant. Such exchange resins can be added during application of a flash coating as described herein or at the end thereof as the coating dries for adhesive-type incorporation into the coated surface.

The processes and compositions described herein are well-suited to the treatment of a variety of proppant solids in a context other than a formal resin-coating operation or facility. As such, the process can be used to apply, for example, a dust suppressing, liquid treatment agent as an uncured coating over at least a portion, such as a large portion, of the proppant solids within the bulk mixture. Such a treatment process affords the possibility that the process can be used to provide the proppant solids with additional properties without the need for a formal, manufacturing facility-based coating process. Such types of additional functionalities are described in our co-pending U.S. patent application Ser. No. 10/872,532 entitled “Dual Function Proppants”, now U.S. Pat. No. 8,763,700, the disclosure of which is hereby incorporated by reference. Such additional materials can include, e.g., pigments, tints, dyes, and fillers in an amount to provide visible coloration in the coatings. Other materials can include, but are not limited to, reaction enhancers or catalysts, crosslinking agents, optical brighteners, propylene carbonates, coloring agents, fluorescent agents, whitening agents, UV absorbers, hindered amine light stabilizers, defoaming agents, processing aids, mica, talc, nano-fillers, impact modifiers, and lubricants. Other additives can also include, for example, solvents, softeners, surface-active agents, molecular sieves for removing the reaction water, thinners and/or adhesion agents can be used. The additives can be present in an amount of about 15 weight percent or less. In one embodiment, the additive is present in an amount of about 0.005-5 percent by weight of the coating composition. The processes described herein can also be used to add other functionalities as described herein.

The proppants described herein can be used in a gas or oil well. For example, the proppants can be used in a fractured subterranean stratum to prop open the fractures as well as use the properties of the proppant in the process of producing the oil and/or gas from the well. In some embodiments, the proppants are contacted with the fractured subterranean stratum. The proppants can be contacted with the fractured subterranean stratum using any traditional methods for introducing proppants and/or sand into a gas/oil well. In some embodiments, a method of introducing a proppant into a gas and/or oil well is provided. In some embodiments, the method comprises placing the proppants into the well.

### EXAMPLES

### Example 1

An ineffective initial test was performed using a poorly designed spray pattern at an existing sand plant. The spray was applied at several sites along the conveyor belt. It was learned that if the sand was not heated, that one would be unlikely to be able to exceed 0.5% addition of the treatment agent in water. The tested coating efficiency was so poor as to not be able to properly evaluate the effectiveness of the treatment agents being tested.

### Example 2

In a second example, the treatment agent solution was applied by hand to sand as it was agitated by a mixer that was used to coat the sand like the equipment used in a conventional coating process. This approach was taken to focus on whether the technology would be effective if uniformly applied. Application levels were tested at levels ranging from a high of 0.5% (by weight) of a mineral oil or a diluted polymer solution having a concentration as low as 0.12% (by weight).

The results showed that, even if perfectly applied, a concentration of 0.5% (by weight) was likely to create a particle surface that was too wet and would likely create issues with moving the treated proppant using conventional handling equipment. A concentration of 0.25% was found to be effective, but a further reduction to 0.12% was somewhat ineffective.

### Example 3

Uncoated, unheated, proppant sand was treated at the rate of 0.25 wt % with a mixture containing acrylic polymers, and alkoxylated alcohols (commercially available under the name ROHMIN DC-5500 Emulsion from Rohm and Haas Chemicals, LLC, 100 Independence mall West, Philadelphia, Pa. 19106). This treatment agent was applied by a plurality of nozzles located on either side of a curtain of sands falling from a conveyor belt. The nozzles formed a cone-shaped fog of fine spray that impinged on the falling sand solids as they fell into a receptacle that fed a pneumatic test pipe through a series of turns to discharge into an open container. Some nozzles were positioned to treat the top portion of the stream coming off the belt while others sprayed from beneath to coat the underside of the particle stream.

All of the treated sand remained dry to the touch and free-flowing. There was no discernible clumping, aggregation or pooling of excess treatment agent.

Compared to the untreated standard, the treated sand showed markedly reduced levels, i.e., subjectively 50-80% reduction, of fugitive dust rising from the open discharge chamber. What solids did rise with ambient air currents produced by the discharge were seen to settle quickly back into the open container.

### Example 4

The same treatment agent as described in Example 3 was used to treat uncoated frac sand at a commercial sand handling facility. The treatment nozzles were disposed on a ring sprayer (as in FIGS. 5 and 6) and whose conical spray patterns were directed to apply treating agent to the falling sand at substantially the same rate as an Example 1. The treated sand then passed through a static mixer of the type shown in FIGS. 3 and 4 in a configuration as shown in FIG. 7. All treatments were done at ambient temperature. Visual observation of showed that the treated sand exhibited substantially the same, marked reduction in fugitive dust from the open discharge and dust carried upwardly from ambient air currents quickly settled down and did not escape the discharge area.

### Example 5

Measurement tests were done on the proppant described in Examples 3 and 4 to compare the effects of the treatment against untreated 30/50 sized sand. The results are shown in Table 4 below.

TABLE 4

| | Uncoated | Formulation |
|---|---|---|
| Bulk Density (lb/ft³) | 94.65 | 99.11 |
| #20 | 0.00 | 0.01 |
| #30 | 0.33 | 2.75 |
| #35 | 10.96 | 22.22 |
| #40 | 46.21 | 45.00 |
| #45 | 30.10 | 18.98 |
| #50 | 9.86 | 7.67 |
| #70 | 2.46 | 3.20 |
| PAN | 0.08 | 0.16 |
| Mean Diameter (mm) | 0.432 | 0.458 |
| MPD (mm) | 0.475 | 0.497 |
| Crush | 8.47% at 8 K | 9.47 at 8 K |
| LOI | 0.10% | 0.12% |
| Turbidity | 198 NTU | 10 NTU |
| Acid Solubility | 0.91% | 0.13% |
| Roundness | 0.7 | 0.7 |
| Sphericity | 0.7 | 0.7 |

Even though the formulation was applied so quickly, the treatment provided an improvement in crush resistance with a significant decrease in turbidity. Turbidity relates to the proportion of small solids suspended in solution. The decrease in turbidity shows that fines are not dispersed in solution in a treated sample but are entrapped or agglomerated in the proppant. This shows the use of the additive treatment is effective for minimization of fines mobility in solution and translates into reduced mobility in air (reduced introduction of dust into the atmosphere after handling of the treated sand vs. the untreated sand).

It was also found that the applied coating also increased the resistance of the treated proppant to the effects of acids (a mixture of 12% hydrochloric and 3% hydrofluoric acids) and increased the K Value (crush resistance) of the treated proppant.

### Examples 6 and 7

Additional tests were performed to measure the compatibility of the dust control treatment on sand with certain properties of a test frac fluid. The frac fluid used guar gum, a natural water soluble polymer.

Example 6 was a crosslink test using a borate crosslinker in 200° F. deionized water compared to water containing the dust control treatment components. The base gel was 20 parts per thousand (ppt) polymer loading and 2.2 grams per thousand (gpt) of the borate crosslinker. The system was buffered to a pH above 8.5 and then crosslinked with the borate solution. The dust additive was the ROHMIN DC-5500 at a concentration of 0.25% by weight. The sand was coated.

The test starts with a slurry of water and 4 pounds/gallon of sand that has been treated with an emulsion containing acrylic acid polymers and a mixture of ethoxylated alcohols. The slurry is heated for an hour at 200° F. while being stirred. In that time, anything that can be extracted from the coating will be moved into the water. The sand is then separated from the water, and the water is then used to make the fracturing fluid system.

At the polymer loading identified above and with a pH in deionized water control of 6.67, the viscosity of the frac fluid was initially 15.4 cp. When crosslinked with the borate, the pH was 11.05.

At 15.4 cp, the pH in deionized water control was 6.67. When crosslinked with the borate, the pH was 11.05. The treatment pH at 15.2 cp was 8.06 initially and was 10.70 when crosslinked.

TABLE 5

| Time | Crosslinked Gel Viscosity at 100 sec⁻¹, cp | |
|---|---|---|
| (min) | Deionized Water | Water with Dust Control |
| 30 | 355 cP | 348 cP |
| 60. | 380 cP | 350 cP |
| 90 | 367 cP | 328 cP |
| 120 min. | 360 cP | 325 cP |

The viscosity data presented in Table 5 shows that the control sample (made in deionized water) had a very similar rheology profile to the fracturing fluid made with the water that had been exposed to the chemicals used in the present dust control treatment process. These tests show that the viscosity increases to >300 cP for both the deionized water and the treated water once the cross-linker is added. Thus, the crosslinking reaction is equivalent in deionized water either with or without the dust control additive. This test result confirms that the chemistry used in the treatment of the present process will not alter or interfere with the rheological properties to the frac fluid.

Example 7 is a breaker test with 200° F. water containing a dissolved sample of the dust control treatment. One purpose of the test is to determine whether a dissolved sample of the dust control treatment adversely affects the efficiency of the frac fluid gel breaker. Stated another way, the test sought to find out whether the chemistry used in the dust additive would require more breaker to decrease the viscosity of the fracturing fluid or change the rate at which the viscosity is decreased with respect to time. The water used in this test was prepared following the same procedure that was explained in connection with Example 6.

TABLE 6

| Time | Crosslinked Gel Viscosity at 100 sec⁻¹, cP | |
|---|---|---|
| (min) | Deionized water | Water with coating material |
| 5 | 829 | 655 |
| 7 | 464 | 446 |
| 10 | 64 | 93 |
| 15 | 6 | 3 |
| 20 | 0 | 0 |

The results from the side by side tests revealed a similar viscosity profile with very similar values from the 7 minute mark until the last reading at the 20 minute mark. Therefore, this industry value test confirms that the coating treatment chemistry has no effect on the efficiency of the breaker system that was tested.

### Example 8

In Example 8, a 40/70 ceramic proppant was treated with 0.003 wt % coating of a water-based emulsion that included a combination of materials including acrylic polymers, C₆-C₁₂ ethoxylated alcohols and C₁₀-C₁₆ ethoxylated alcohols. The coating had three positive effects: (1) it decreased the ceramic's turbidity from 524 NTU's to 110; (2) it decreased the solubility of the ceramic in 12% HCL and 3% HF acid from 3.4% to 2.6%, and (3) it increased the K Value from 13 to 15. These results could not have been predicted based upon the process that the proppant was coated with.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Various references and patents are disclosed herein, each of which are hereby incorporated by reference for the purpose that they are cited.

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting.

What is claimed is:

1. A proppant comprising a particle and a coating disposed on the particle, wherein the coating comprises a surfactant and an acrylic polymer.

2. The proppant of claim 1, wherein the acrylic polymer is a copolymer.

3. The proppant of claim 2, wherein the copolymer is a copolymer of an acrylamide and an unsaturated aliphatic compound.

4. The proppant of claim 2, wherein the copolymer is a copolymer of a carboxylic acid monomer and an unsaturated aliphatic compound.

5. The proppant of claim 3, wherein the unsaturated aliphatic compound is an unsaturated aliphatic carboxylic acid.

6. The proppant of claim 4, wherein the unsaturated aliphatic compound is an unsaturated aliphatic carboxylic acid.

7. The proppant of claim 3, wherein the wherein the unsaturated aliphatic compound is 2-chloroacrylic acid, 2-bromoacrylic acid, maleic acid, fumaric acid, itaconic acid, methacrylic acid, or mesaconic acid.

8. The proppant of claim 4, wherein the wherein the unsaturated aliphatic compound is 2-chloroacrylic acid, 2-bromoacrylic acid, maleic acid, fumaric acid, itaconic acid, methacrylic acid, or mesaconic acid.

9. The proppant of claim 3, wherein the unsaturated compound is acrylonitrile, methyl acrylate, methyl methacrylate, vinyl acetate, vinyl propionate, methyl itaconate, styrene, or 2-hydroxylethyl methacrylate.

10. The proppant of claim 4, wherein the unsaturated compound is acrylonitrile, methyl acrylate, methyl methacrylate, vinyl acetate, vinyl propionate, methyl itaconate, styrene, or 2-hydroxylethyl methacrylate.

11. The proppant of claim 1, wherein the surfactant is an alkoxylated alcohol.

12. The proppant of claim 1, wherein the coating comprises a metal.

13. The proppant of claim 2, wherein the metal is zinc.

14. The proppant of claim 1, wherein the coating disposed on the particle is formed from an aqueous composition comprising the surfactant and the acrylic polymer.

15. The proppant of claim 14, wherein the acrylic polymer is a copolymer.

16. The proppant of claim 15, wherein the copolymer is a copolymer of an acrylamide and an unsaturated aliphatic compound.

17. The proppant of claim 15, wherein the copolymer is a copolymer of a carboxylic acid monomer and an unsaturated aliphatic compound.

18. A process for preparing the proppant of claim 1, the method comprising applying the coating comprising the surfactant and the acrylic polymer to the particle.

19. The process of claim 18, wherein the coating is an aqueous composition comprising the surfactant and the acrylic polymer.

20. A method of reducing fugitive dust from a method of hydraulic fracturing comprising using the proppant of claim 1 in the method of hydraulic fracturing.
